(19) United States
(12) Patent Application Publication
(10) Pub. No.: US 2009/0283155 A1
(43) Pub. Date: Nov. 19, 2009

(54) Fluid control system

(75) Inventors: Kenro Yoshino, Miyazaki (JP); Shinobu Kamimura, Miyazaki (JP)

Correspondence Address: BUCHANAN, INGERSOLL & ROONEY PC, POST OFFICE BOX 1404, ALEXANDRIA, VA, 22313-1404, US

(73) Assignee: ASAHI ORGANIC CHEMICALS INDUSTRY, NOBEOKA-SHI (JP)

(21) Appl. No.: 11/990,138

(22) PCT Filed: Aug. 21, 2006
(86) PCT No.: PCT/JP2006/316782

§ 371 Date: Feb. 7, 2008

(30) Foreign Application Priority Data
Aug. 22, 2005 (JP) 2005-240277

(51) Int. Cl. F16K 31/02

(52) U.S. Cl. 137/487.5

(57) ABSTRACT

The fluid control system according to the present invention is characterized by being provided with a fluid control valve controlling a pressure of a fluid by a pressure operation of a control fluid, a flow rate measuring device measuring a flow rate of the fluid, converting a measurement value of said flow rate to an electrical signal, and outputting it, and a control part outputting a command signal for controlling an opening area of said fluid control valve to said fluid control valve or equipment operating said fluid control valve based on a difference of said electrical signal from said flow rate measuring device and a set flow rate.

### TECHNICAL FIELD

The present invention relates to a fluid control system used for a fluid transport pipe where fluid control is required. More particularly, it relates to a fluid control system mainly installed in a semiconductor production facility etc., facilitating piping and wiring, enabling control of the flow rate without problem even when a pulsating fluid is flowing, and enabling fine control of the flow rate over a broad flow rate range.

### BACKGROUND ART

In the past, as one step in the process of production of semiconductors, wet etching using a washing solution comprised of fluoric acid or another chemical diluted by pure water to etch the surface of a wafer has been used. It is considered necessary to manage the concentration of the washing solution of the wet etching with a high precision. In recent years, the method of managing the concentration of the washing solution by the ratio of flow rates of the pure water and chemical has become the mainstream. For this reason, a fluid control system managing the flow rate of pure water or chemicals with a high precision has been applied.

Various fluid control systems have been proposed. There has been a control system 301 of the flow rate of pure water which controls the flow rate when making the temperature of the pure water variable such as shown in FIG. 18 (for example, see Japanese Patent Publication (A) No. 11-161342). This was configured as a control system 301 provided with a flow rate adjusting valve 302 adjusted in opening degree when receiving the action of operating pressure for adjusting a flow rate of pure water, an operating pressure adjusting valve 303 for adjusting the operating pressure supplied to the flow rate adjusting valve 302, a flow rate measuring device 304 for measuring the flow rate of pure water output from the flow rate adjusting valve 302, and a shutoff valve 305 for allowing or cutting off the flow of pure water passing through the flow rate measuring device 304, which balanced the operating pressure adjusted by the operating pressure adjusting valve 303 and the outlet pressure of the pure water at the flow rate adjusting valve 302 so as to control the flow rate of the pure water output from the flow rate adjusting valve 302 to be constant, characterized by making the measurement value by the flow rate measuring device 304 become constant by providing a control circuit for feedback control of the operating pressure supplied from the operating pressure adjusting valve 303 to the flow rate adjusting valve 302 based on that measurement value. The effect was that even if the output pressure at the flow rate adjusting valve 302 changed along with a change of temperature of the pure water, the operating pressure was adjusted in real time according to that change whereby the flow rate of the pure water output from the flow rate adjusting valve 302 was adjusted, so the flow rate of the pure water could be maintained at a constant value at a high precision.

Further, as a fluid control system based on electrical drive with parts provided inside a single casing, there was a fluid control module 306 as shown in FIG. 19 connected in-line to a fluid circuit transporting a fluid (for example, see Japanese Patent Publication (A) No. 2001-242940). This was configured by provision of a housing 307 having a chemically inert passage, an adjustable control valve 308 connected to the passage, a pressure sensor 309 connected to the passage, and a constricted part 310 positioned in the passage, the control valve 308 and the pressure sensor 309 housed in the housing 307, and further having a driver 311 provided with an electric motor for electrically driving the control valve 308 and a controller 312 electrically connected to the control valve 308 and the pressure sensor 309 housed in the housing 307. The effect was that by measuring the flow rate in the passage from the pressure difference measured in the fluid circuit and the diameter of the constricted part 310 and driving the control valve 308 by feedback control based on the measured flow rate, it was possible to determine the flow rate in the passage with a high precision.

However, said conventional pure water flow rate control system 301 balanced with the outlet pressure of the pure water at the flow rate adjusting valve 302 so as to control the flow rate of the pure water output from the flow rate adjusting valve 302 to a constant value, so was not suited to fine control of the flow rate. The flow rate range was also not that wide, so there was the problem that this was hard to use for applications controlling the flow rate over a broad flow rate range. Further, the components are split into numerous parts, so when installing the system inside a semiconductor production facility etc., it was necessary to perform work for connecting the piping among the components and the work of electrical wiring and air piping. The work was complicated and required time. Further, the piping and wiring were troublesome and mistakes were liable to be made.

Further, said conventional flow rate control module 306 had the problem that when the fluid flowing into the fluid control system was a pulsating flow with a short period of fluctuation of pressure, the control valve 308 would operate to try to control the flow rate for the pulsating fluid, but there was the problem that hunting would occurred and flow rate control would no longer be possible and, if continued as is, the driver 311 or the control valve 308 would end up breaking down. Further, the flow rate range for control of the flow rate was not that wide, so there was the problem that this was hard to use for applications controlling the flow rate over a broad flow rate range.

### DISCLOSURE OF THE INVENTION

The present invention was made in consideration of the above problems in the prior art and has as its object the provision of a fluid control system facilitating installation, piping, and wiring in a semiconductor production facility etc., enabling control of the flow rate without problem even when a pulsating fluid flows, and enabling fine control of the flow rate over a broad flow rate range.

The configuration of the fluid control system of the present invention for solving the above problems will be explained based on FIGS. 1 to 17. The fluid control system 1 of the present invention is provided with a fluid control valve 4 controlling a pressure of a fluid by a pressure operation of a control fluid, a flow rate measuring device 3 measuring a flow rate of the fluid, converting a measurement value of said flow rate to an electrical signal, and outputting it, and a control part 6 outputting a command signal for controlling an opening area of said fluid control valve 4 to said fluid control valve 4 or a piece of equipment 56 operating said fluid control valve based on a difference between the electrical signal from the flow rate measuring device 3 and a set flow rate as a first characterizing feature.

Note that the “control fluid” means, for example, air, working oil, etc.

Further, the device is further provided with a shutoff valve 61 for opening or cutting off the flow of the fluid as a second characterizing feature as a second characterizing feature.

Further, the device is further provided with a throttle valve 85 adjustable in opening area as a third characterizing feature.

Further, said valves 4, 61, and 85 and said flow rate measuring device 3 are directly connected without using independent connecting means as a fourth characterizing feature. The “independent connecting means” mean separate tubes, connecting pipes, etc.

Further, said valves 4, 61, and 85 and said flow rate measuring device 3 are arranged in a single base block 147 as a fifth characterizing feature.

Further, said fluid control valve 4 is provided with a main body 12 having a second cavity 20 provided at a center of the bottom part and opening at a base part, an inlet passage 22 communicating with the second cavity 20, a first cavity 21 provided at a top part with a top face open and having a diameter larger than a diameter of the second cavity 20, an outlet passage 23 communicating with the first cavity 21, and a communicating hole 24 communicating the first cavity 21 and second cavity 20 and having a diameter smaller than the diameter of the first cavity 21, a top face of the second cavity 20 made a valve seat 25; a bonnet 13 having inside it a cylindrical cavity 26 communicating with an air feed hole 28 and exhaust hole 29 provided at a side face or top face and provided with a step part 27 at an inner circumference of a bottom end; a spring retainer 14 inserted into the step part 27 of the bonnet 13 and having a through hole 30 at its center; a piston 15 having at its bottom end a first connecting part with a smaller diameter than the through hole 30 of the spring retainer 14, provided at its top part with a flange 33, and inserted inside the cavity 26 of the bonnet 13 to be vertically movable; a spring 16 supported gripped by a bottom end face of the flange 33 of the piston 15 and a top end face of the spring retainer 14; a first valve mechanism 17 having a first diaphragm 38 having a peripheral edge fastened by being gripped between the main body 12 and the spring retainer 14 and having a center part forming a first valve chamber 42 in a manner capping the first cavity 21 of the main body 12 made thick, a second connecting part 40 provided at the center of its top face passing through the through hole 30 of the spring retainer 14 and fastened by being connected to the first connecting part 35 of the piston 15, and a third connecting part 41 provided at the center of its bottom face passing through the communicating hole 24 of the main body 12; a second valve mechanism 18 having a valve element 43 positioned inside the second cavity 20 of the main body and provided in a larger diameter than the communicating hole 24 of the main body, a fourth connecting part 45 provided sticking out at the top end face of the valve element 43 and being fastened by being connected with the third connecting part 41 of the first valve mechanism 17, a rod 46 provided sticking out from a bottom end face of the valve element 43, and a second diaphragm 48 provided extending out from the bottom end face of the rod 46 in the radial direction; and a baseplate 19 positioned below the main body 12, having at the center of its top part a projecting part 50 fastening the peripheral edge of the second diaphragm 48 of the second valve mechanism 18 by gripping it with the main body 12, provided with a cut recess 51 at a top end of the projecting part 50, and provided with a breathing hole 52 communicating with the cut recess 51; an opening area of a fluid control part 53 formed by the valve element 43 of the second valve mechanism 18 and the valve seat 25 of the main body 12 changing along with vertical motion of the piston 15 as a sixth characterizing feature.

Note that the basic configuration of this control valve is disclosed in Japanese Patent Publication (A) No. 2004-38571.

Further, said fluid control valve 169 has a main body part 170 formed from a fluid inlet passage 194, outlet passage 201, and chamber 176 at which the inlet passage 194 and outlet passage 201 are communicated, a valve member 185 having a valve element 214 and a first diaphragm part 186, and a second diaphragm part 187 and third diaphragm part 188 positioned at the bottom part and top part of the valve member 185 and having an effective pressure receiving area smaller than the first diaphragm part 186, the valve member 185 and diaphragm parts 186, 187, and 188 being attached in the chamber 176 by the outer circumferences of the diaphragm parts 186, 187, and 188 being fixed to the main body part 170, the diaphragm parts 186, 187, and 188 dividing the chamber 176 into a first pressurization chamber 177, a second valve chamber 178, a first valve chamber 179, and a second pressurization chamber 180, the first pressurization chamber 177 having means for applying a constant inwardly oriented force to the second diaphragm part 187, the first valve chamber 179 communicating with the inlet passage 194, the second valve chamber 178 having a valve seat 199 corresponding to the valve element 214 of the valve member 185 and being formed divided into a bottom second valve chamber 181 positioned at the first diaphragm part 186 side with respect to the valve seat 199 and communicating with the first valve chamber 179 by a communicating hole 211 provided in the first diaphragm part 186 and a top second valve chamber 182 positioned at the second diaphragm part 187 side and provided communicating with the outlet passage 201 and has a fluid control part 217 where vertical motion of a valve member 185 changes an opening area between the valve element 214 and valve seat 199 and controls a fluid pressure of the bottom second valve chamber 181, and the second pressurization chamber 180 has means for applying a constant inwardly directed force to the third diaphragm part 189 as a seventh characterizing feature.

Note that the basic configuration of this control valve is disclosed in Japanese Patent Publication (A) No. 2004-176812.

Further, said throttle valve 85 is provided with a main body 88 formed with a valve seat face 89 at a bottom face of a valve chamber 90 provided at the top and having an inlet passage 92 communicating with a communicating port 91 provided at the center of the valve seat face 89 and an outlet passage 93 communicating with the valve chamber 90; a diaphragm 97b comprised of a first valve element 98 able to be inserted into the communicating port 91 by an advancing/retracting motion of a stem in the axial direction and provided vertically from the center of the surface contacting the liquid, a ring-shaped projecting second valve element 99 able to approach/separate from the valve seat face 98 and formed at a position isolated from the first valve element 98 in the radial direction, and a thin film part 100 formed continuously from the second valve element 99 toward the radial direction—all provided integrally; a first stem 114 fastened at its top with a handle 119 and having at an inner circumference of its bottom part a female thread part 115 and having at its outer circumference a male thread part 116 having a pitch large than a pitch of the female thread part 115; a first stem support member 121 having at its inner circumference a female thread part 122 to be screwed with the male thread part 116 of the first stem 114; a second stem 106 having at an outer circumference of its top a male thread part 107 to be screwed with the female thread part 115 of the first stem 114 and connected at its bottom end with the diaphragm 97; a diaphragm holder 108 positioned below the first stem support member 121 and supporting the second stem 106 so as to be able to move vertically and not to be able to rotate; and a bonnet 125 fixing the first stem 114 and diaphragm holder 108 as an eighth characterizing feature.

Note that the basic configuration of this control valve is disclosed in Japanese Patent Publication (A) No. 2005-155878.

Further, said flow rate measuring device 3 is an ultrasonic flowmeter or ultrasonic type vortex flowmeter as a ninth characterizing feature.

In the present invention, the fluid control valve 4 is not particularly limited so long as it enables control of the pressure of a fluid by a pressure operation of a control fluid, but one having the configuration of the fluid control valve 4 of the present invention controlling the pressure of a fluid such as shown in FIG. 2 or the fluid control valve 169 of the present invention controlling the flow rate of a fluid such as shown in FIG. 13 is preferable. This enables stable fluid control, enables stabilization of the pressure or flow rate to a constant pressure by the fluid control valves 4, 169 even if a pulsating fluid flows, enables the passage to be shut by just the fluid control valves 4, 169, and enables a compact configuration and small fluid control system 1, so is preferable.

In the present invention, the flow rate measuring device 3 is not particularly limited so long as it converts the measured flow rate to an electrical signal and outputs it to the control part 6, but a ultrasonic flowmeter or ultrasonic type vortex flowmeter is preferable. In particular, in the case of the ultrasonic flowmeter such as shown in FIG. 1 or FIG. 15, a fine flow rate can be measured precisely, so this is preferable for fine flow rate fluid control. Further, in the case of the ultrasonic type vortex flowmeter as shown in FIG. 16, a large flow rate can be precisely measured, so this is preferable for large flow rate fluid control. In this way, by selectively using an ultrasonic flowmeter and ultrasonic type vortex flowmeter in accordance with the flow rate of the fluid, precise fluid control is possible.

Further, the present invention, as shown in FIG. 3, may also provide the fluid control system 59 with a shutoff valve 61. This is preferable since by providing the shutoff valve 61, it is possible to shut the shutoff valve 61 to facilitate maintenance, repair, and exchange of parts of the fluid control system 59 (hereinafter referred to as “maintenance etc.”) Further, if providing the fluid control system 59 with the shutoff valve 61, when shutting the passage and disassembling the fluid control system 59 for maintenance etc., it is possible to suppress to a minimum the leakage of fluid remaining in the passage from the disassembled parts. Furthermore, when some sort of trouble occurs in the passage, the shutoff valve 61 can cut off the fluid on an emergency basis, so this is preferred.

Further, the shutoff valve 61 is not particularly limited in its configuration so long as it has the function of opening or cutting off the flow of fluid. It may be manually operated or may be automatically operated by air, electricity, electromagnetic drive, etc. In the case of automatic operation, it is possible to provide a control circuit to link up with the fluid control valve 63 or flow rate measuring device 62 of the fluid control system 59 and drive the shutoff valve 61 in accordance with the state of the fluid control valve 63 or the flow rate or drive it independently from the fluid control system 59. If driven linked with the fluid control system 59, overall control in the fluid control system 59 is possible, so this is preferred. If driven independent of the fluid control system 59, when trouble occurs in the fluid control system 59 and the shutoff valve 61 is used to cut off the passage on an emergency basis, the valve can be driven without being affected by the trouble of the fluid control system 59, so this is preferred.

Further, for the installation position of the shutoff valve 61, for maintenance etc., installation at the upstream side of the other valve 63 and flow rate measuring device 62 is preferable. Furthermore, it is possible to provide a plurality of shutoff valves 61 at both the upstream side and downstream side of the other valve 63 and flow rate measuring device 62. At this time, by closing both shutoff valves 61, the flows at the upstream side and the downstream side of the fluid control system 59 are stopped, so backflow of the fluid is prevented and leakage of fluid at the time of performing maintenance etc. is reliably prevented, so this is preferred.

Further, the present invention, as shown in FIG. 5, can provide the fluid control system 81 with a throttle valve 85. This is preferable because in particular by providing the throttle valve 85 in the fluid control valve 84 for controlling the pressure, after the fluid control valve 84 controls the pressure to a constant level, the throttle valve 85 can be used to adjust the flow rate to a constant level for the outflow of fluid and, furthermore, by changing the opening degree of the throttle valve 85, it is possible to change the flow rate and control the flow rate over a broad flow rate range, so this is preferred. The throttle valve 85 is not particularly limited so long as it is configured to variably adjust the passage opening degree and constrict the passage to stabilize the flow rate, but one having the configuration of the throttle valve 85 of the present invention as shown in FIG. 6 is preferable. This enables adjustment of the flow rate over a broad flow rate range and enables easy and accurate adjustment of the fine opening degree of the throttle valve 85, so can finely adjust the opening degree in a short time and does not take up space in the height direction and is therefore compact in structure and enables the fluid control system 81 to be provided small, so is preferred.

Further, in FIG. 6, the pitch difference between the male thread part 116 provided at the outer circumference of the first stem 114 of the throttle valve 85 and the female thread part 115 provided at the inner circumference of the bottom is formed to become ⅙ of the pitch of the male thread part 116, but the pitch difference is preferably provided in the range of 1/20 to ⅕ of the male thread pitch. To enable the valve element to give a certain range of lift from fully closed to fully open by preventing the stroke of the handle 119 from becoming too great and the valve height from becoming too large, the pitch difference should be made greater than 1/20 of the male thread pitch. To enable the valve to be adjusted precisely on a fine order, the pitch difference should be made smaller than ⅕ of the male thread pitch.

Further, in FIG. 7, the outside diameter D₁ of the straight part 104 of the first valve element 98 is set to 0.97 D with respect to the inside diameter D of the communicating port 91, but the outside diameter D₁ of the straight part 104 is preferably in the range of 0.95 D≦D₁≦0.995 D with respect to the inside diameter D of the communicating port 91. To prevent the first valve element 98 and the communicating port 91 from sliding contact, D₁≦0.995 D is preferable. To smoothly adjust the flow rate, 0.95 D≦D₁ is preferable.

Further, the taper angle of the taper part 105 of the first valve element 98 is set to 15° with respect to the axis, but is preferably in the range of 12° to 28°. To prevent the valve from becoming too large and enable adjustment over a broad flow rate range, it should be 12° or more. To prevent the flow rate from rapidly changing with respect to the opening degree, it should be 28° or more. Further, the diameter D₂ of the ring-shaped projection of the second valve element 99 is set to 1.5 D of the inside diameter D of the communicating port 91, but the diameter D₂ of the ring-shaped projection of the second valve element 99 is preferably in the range of 1.1 D≦D₂≦2 D with respect to the inside diameter D of the communicating port 91. To enable the reliable provision of the ring-shaped groove 102 between the first valve element 98 and the second valve element 99 and suppress the flow of fluid into the ring-shaped groove 102, 1.1 D≦D₂ is preferable, while to keep down the rate of increase of the opening area formed between the second valve element 99 and the valve seat face 89 with respect to the opening degree, D₂≦2 D is preferable.

The fluid control system 1 of the present invention may in accordance with need be provided with a pressure adjusting valve for adjusting the fluctuating pressure of the flow flowing into it to a constant pressure for outflow. The pressure adjusting valve used may have the same structure as the fluid control valves 4 and 169.

In the fluid control system of the present invention, as shown in FIG. 1, FIG. 3, FIG. 5, and FIG. 10, the adjoining valves 4, 61, 85 and flow rate measuring device 3 are preferably directly connected without using tubes, connecting pipes, or other independent connecting means. This is because by having the different components directly connected without using tubes or connecting pipes, the fluid control system 1 can be made compact and the space taken up at the installation place can be reduced, the installation work becomes easy and the work time can be shortened, and the passage in the fluid control system 1 can be shortened to the minimum required length, so the fluid resistance can be suppressed. At this time, the valves 4, 61, and 85 and the main body of the flow rate measuring device 3 may also be configured using the same base block. It is also possible to directly connect separate members with the interposition of connecting members 57 and 58 for sealing the passage and changing the direction of the passage. In the case of this configuration, maintenance of the flow rate measuring device 3 becomes particularly easy, so this is preferable.

In the fluid control system of the present invention, as shown in FIG. 11, the valves 141, 143, 144 and the flow rate measuring device 142 are preferably arranged in a single base block 147 formed in the passage. This is preferable since by arranging the components in a single base block 147, the fluid control system 139 can be made compact and the space taken up at the installation place can be reduced, the installation work becomes easy and the work time can be shortened, and the passage in the fluid control system 139 can be shortened to the minimum required length, so the fluid resistance can be suppressed. Furthermore, the number of parts can be reduced, so assembly of the fluid control system 139 can be facilitated, so this is preferable.

The order of arrangement of the flow rate measuring device 3, fluid control valve 4, shutoff valve 61, and throttle valve 85 of the present invention may be any order and is not particularly limited, but the throttle valve 85 is preferably positioned at the downstream side of the fluid control valve 4 and flow rate measuring device 3.

Further, the fluid control system of the present invention may be used for any application where it is necessary to control the flow rate of the fluid to be constant by any value, but is suitably placed in a semiconductor production facility. As front-end steps in the process of production of semiconductors, a photoresist coating step, pattern exposure step, etching step, flattening step, etc. may be mentioned. When managing the concentrations of these washings by the ratio of flow rates of pure water and the chemicals, the fluid control system of the present invention is preferably used.

Further, the parts of the flow rate measuring device 3, fluid control valve 4, shutoff valve 61, and throttle valve 85 of the present invention, if made from a resin, may be polyvinyl chloride, polypropylene (hereinafter referred to as “PP”), polyethylene, etc., but when a corrosive fluid is used as the fluid, polytetrafluoroethylene (hereinafter referred to as “PTFE”), polyvinylidene fluoride (hereinafter referred to as “PVDF”), tetrafluoroethylene-perfluoroalkylvinyl ether copolymer resin (hereinafter referred to as “PFA”), or another fluororesin is preferable. If made of a fluororesin, use for a corrosive fluid is possible. Further, even if a corrosive gas passes through them, there is no longer any concern over corrosion of the valves 4, 61, 85 and flow rate measuring device 3, so this is preferable.

The present invention is structured as explained above and gives the following superior effects:

(1) By using the fluid control system for feedback control, it is possible to stabilize the flow rate of the fluid to a set flow rate with a good response.

(2) The components of the fluid control system are directly connected without using tubes, connecting pipes, or other independent connecting means, so the fluid control system can be made compact and the space of the installation location can be reduced, the installation work becomes easy and the work time can be shortened, and the passage inside the fluid control system can be shortened to the minimum necessary extent, so the fluid resistance can be kept down.

(3) By arranging the fluid control system in a single base block formed with a passage, the fluid control system can be made compact and the space at the installation location can be reduced, the installation work becomes easy and the work time can be shortened, and the passage in the fluid control system can be shortened to the minimum necessary limit, so the fluid resistance can be kept down. Furthermore, the number of parts can be reduced, so assembly of the fluid control system can be facilitated.

(4) By using the fluid control valve of the configuration of the present invention, stable fluid control is possible. Even if a pulsating fluid flows, the fluid control valve can be used to stabilize the pressure or flow rate to a constant one. The fluid control valve alone is enough for opening and closing the passage and the configuration is compact, so the fluid control system can be provided small.

(5) By providing the fluid control system with a shutoff valve, it is possible to close the shutoff valve so as to maintain, repair, and replace parts of the fluid control system easily without leakage of fluid and possible to use the shutoff valve to cut off the fluid on an emergency basis when some sort of trouble occurs in the passage.

(6) By providing the fluid control system with a throttle valve, after using the fluid control valve to control the fluid to a constant pressure, the throttle valve can be used to adjust the fluid to a constant flow rate for outflow. Furthermore, by changing the opening degree of the throttle valve, the flow rate can be controlled over a broad flow rate range.

(7) By using the throttle valve of the configuration of the present invention, it is possible to adjust the flow rate over a broad flow rate range and furthermore possible to easily and precisely adjust the fine opening degree of the throttle valve, so it is possible to finely adjust the opening degree in a short time. Further, not that much space is taken in the height direction and the structure is compact, so the fluid control system can be provided small.

Below, the present invention will be able to be more sufficiently understood from the attached drawings and the description of the preferred embodiments of the present invention.

### BRIEF DESCRIPTION OF THE DRAWINGS

FIG. 1 is a vertical cross-sectional view of a fluid control system showing a first embodiment of the present invention.

FIG. 2 is an enlarged view of a fluid control valve of FIG. 1.

FIG. 3 is a vertical cross-sectional view of a fluid control system showing a second embodiment of the present invention.

FIG. 4 is an enlarged view of a shutoff valve of FIG. 2.

FIG. 5 is a vertical cross-sectional view of a fluid control system showing a third embodiment of the present invention.

FIG. 6 is an enlarged view of a throttle valve of FIG. 5.

FIG. 7 is an enlarged view of principal parts showing the throttle valve of FIG. 6 in the open state.

FIG. 8 is an enlarged view of principal parts showing the throttle valve of FIG. 6 in the closed state.

FIG. 9 is an enlarged view of principal parts showing the throttle valve of FIG. 6 in the semi-open state.

FIG. 10 is a vertical cross-sectional view of a fluid control system showing a fourth embodiment of the present invention.

FIG. 11 is a vertical cross-sectional view of a fluid control system showing a fifth embodiment of the present invention.

FIG. 12 is a vertical cross-sectional view of a fluid control system showing a sixth embodiment of the present invention.

FIG. 13 is an enlarged view of a fluid control valve of FIG. 12.

FIG. 14 is the same view as FIG. 13 adding another display to FIG. 13.

FIG. 15 is a vertical cross-sectional view of a fluid control system showing a seventh embodiment of the present invention.

FIG. 16 is a vertical cross-sectional view of a fluid control system showing an eighth embodiment of the present invention.

FIG. 17 is a cross-sectional view along the line A-A of FIG. 16.

FIG. 18 is a conceptual view of the configuration showing a conventional pure water flow rate control system.

FIG. 19 is a partial cross-sectional view showing a conventional fluid control module.

### BEST MODE FOR CARRYING OUT THE INVENTION

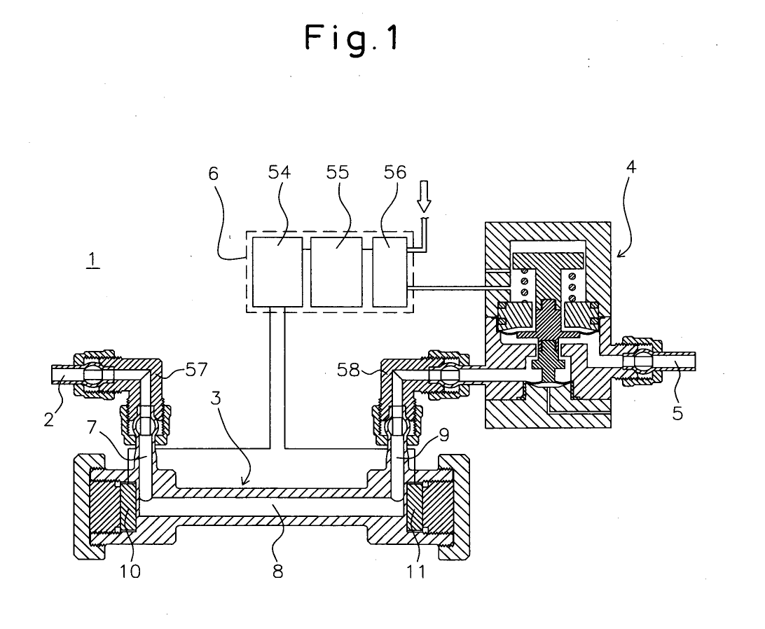

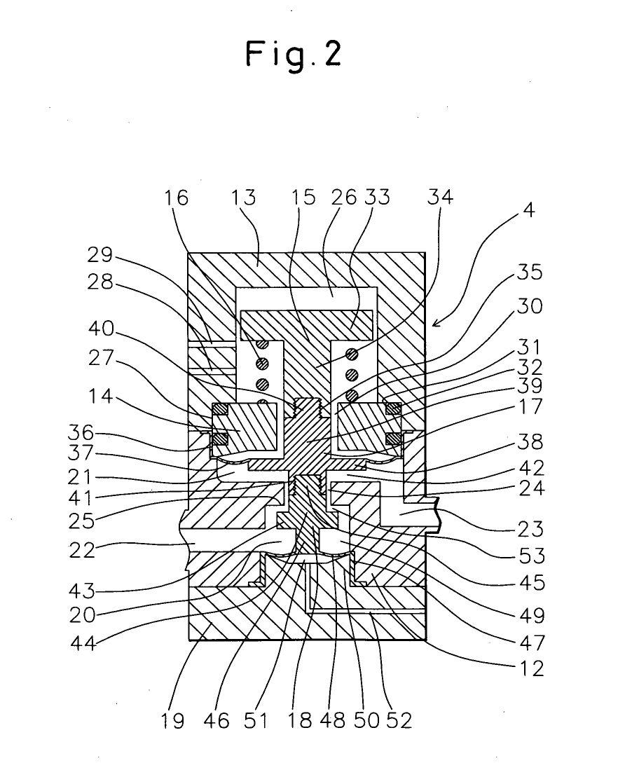

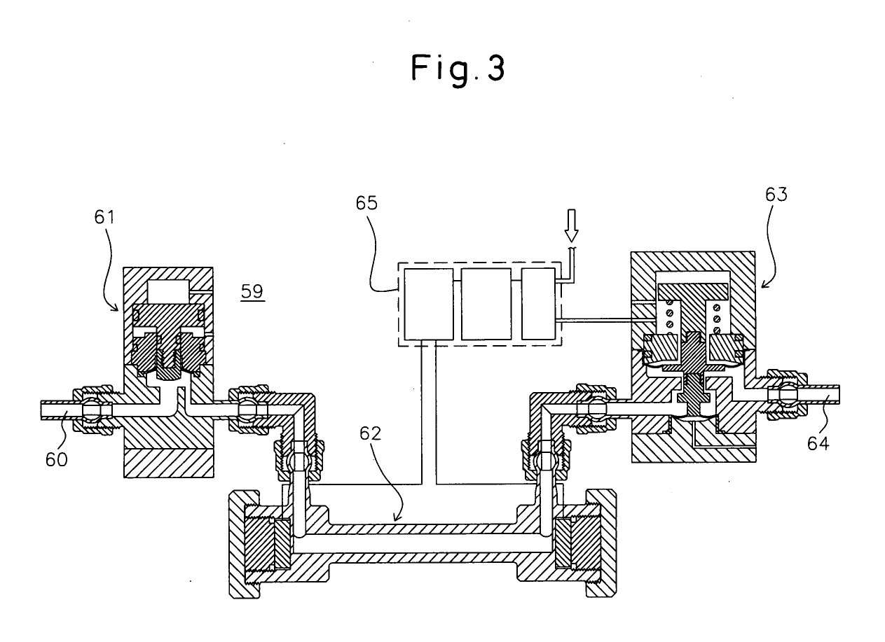

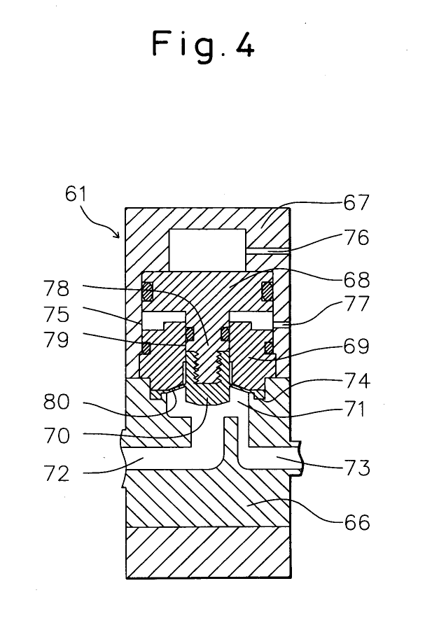

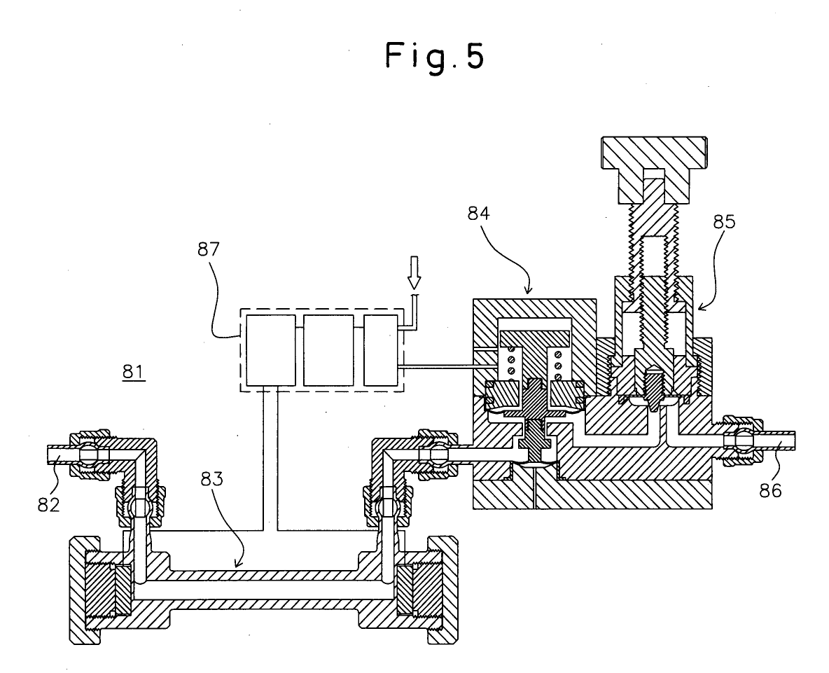

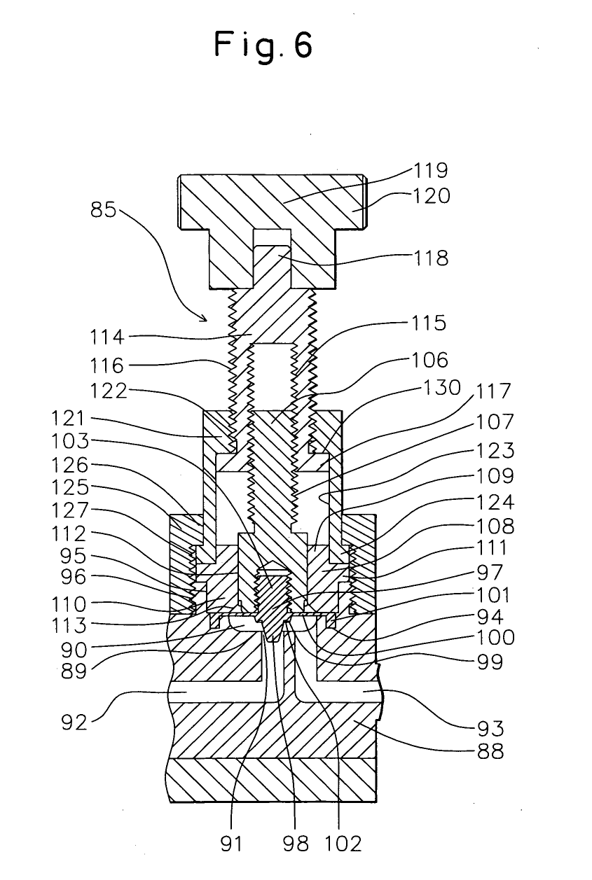

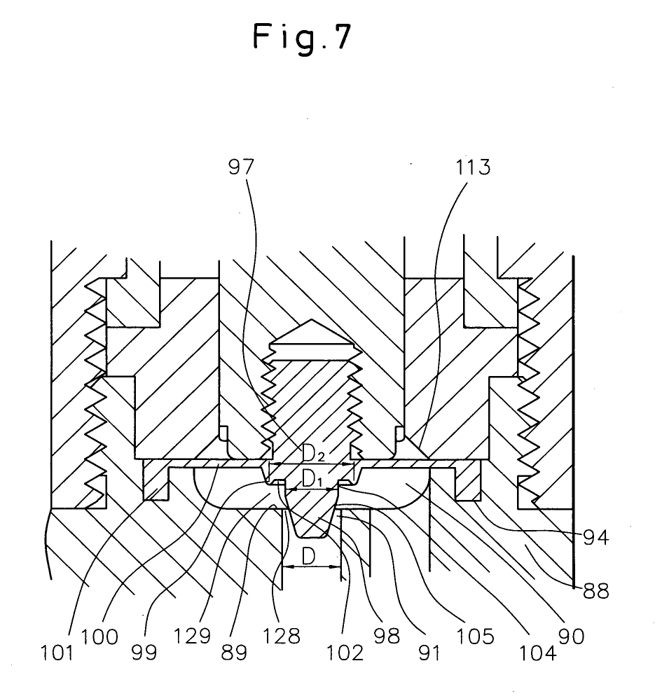

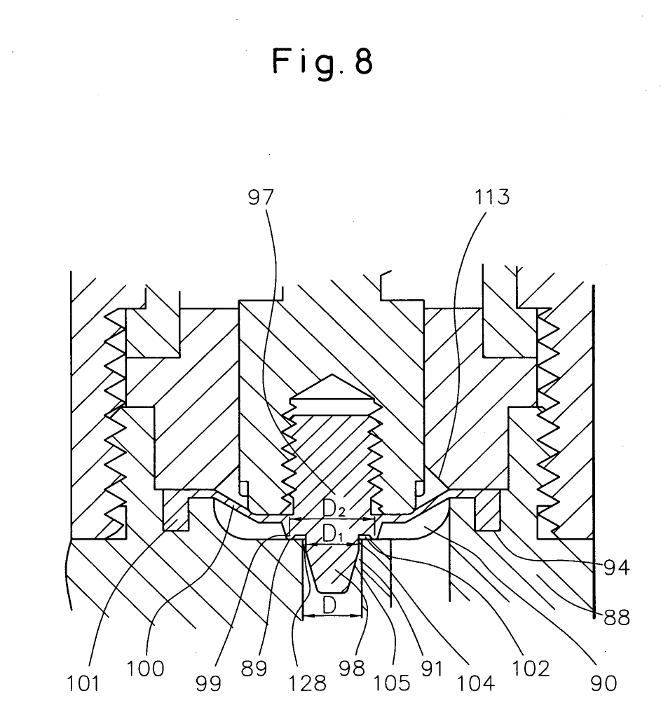

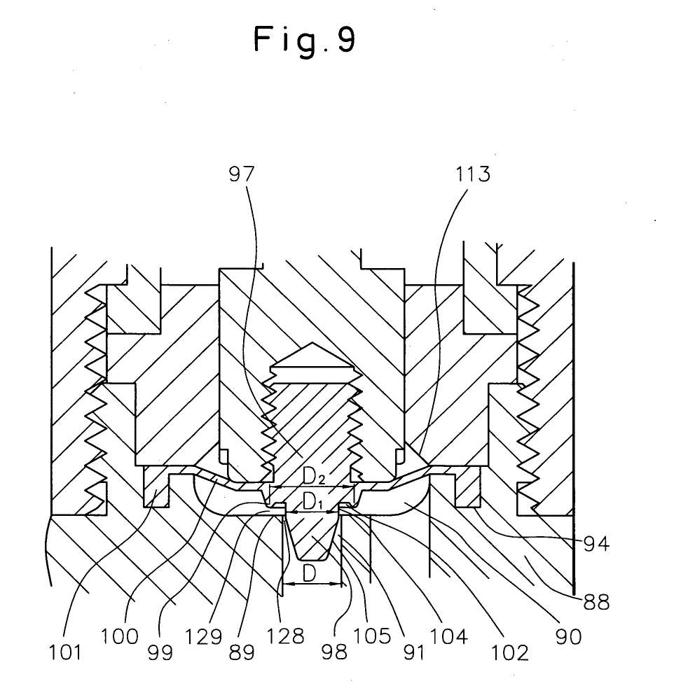

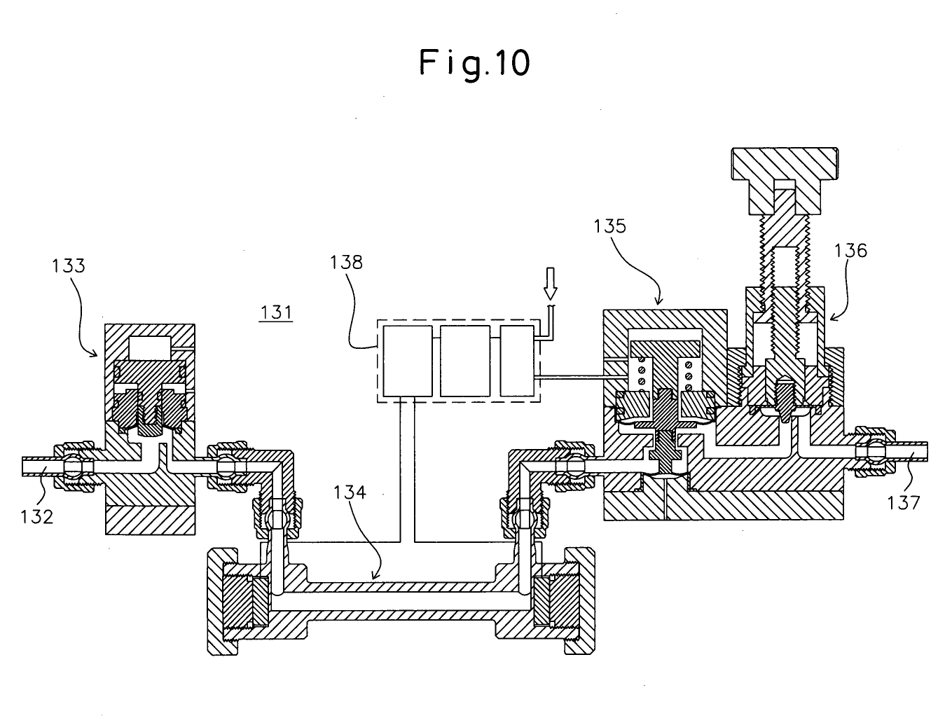

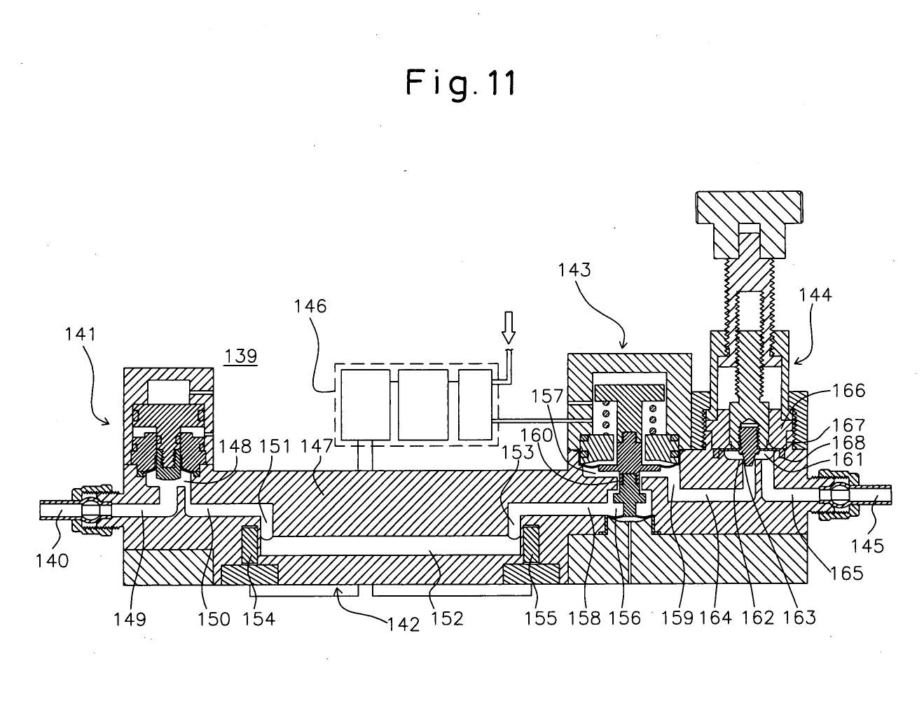

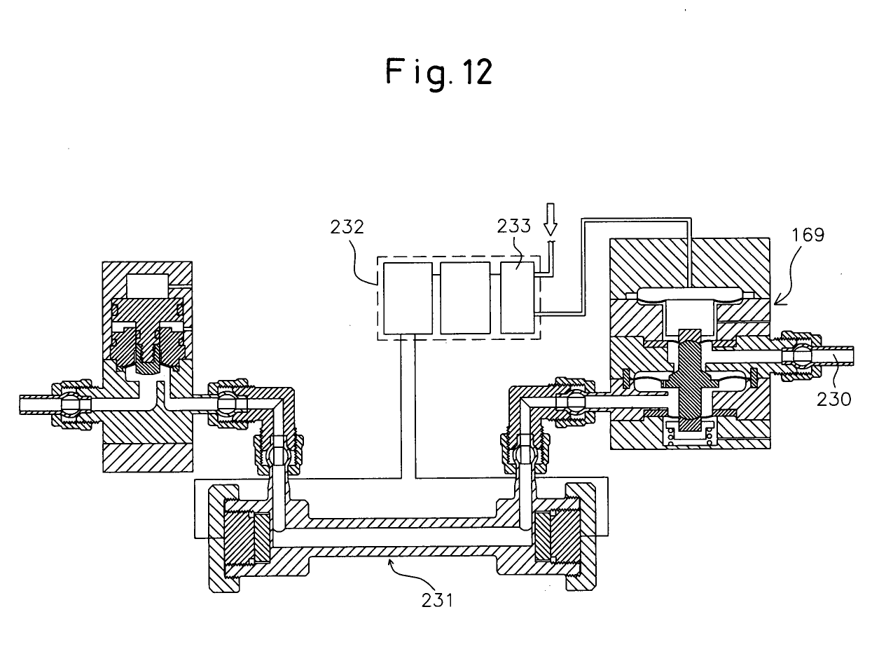

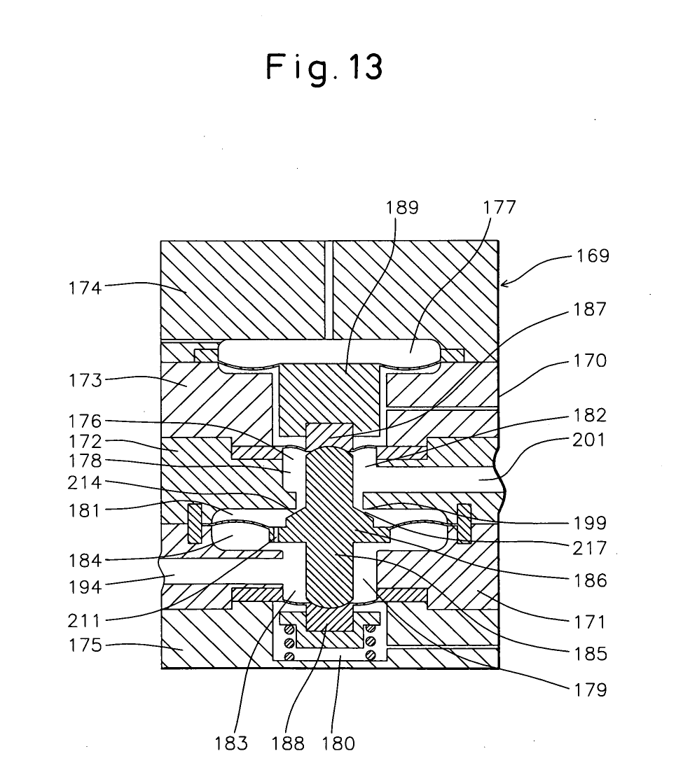

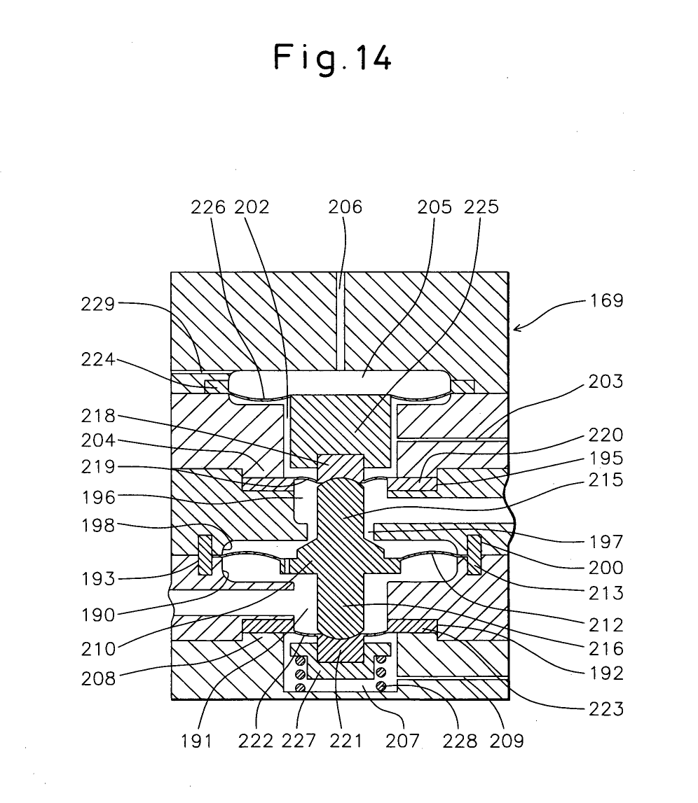

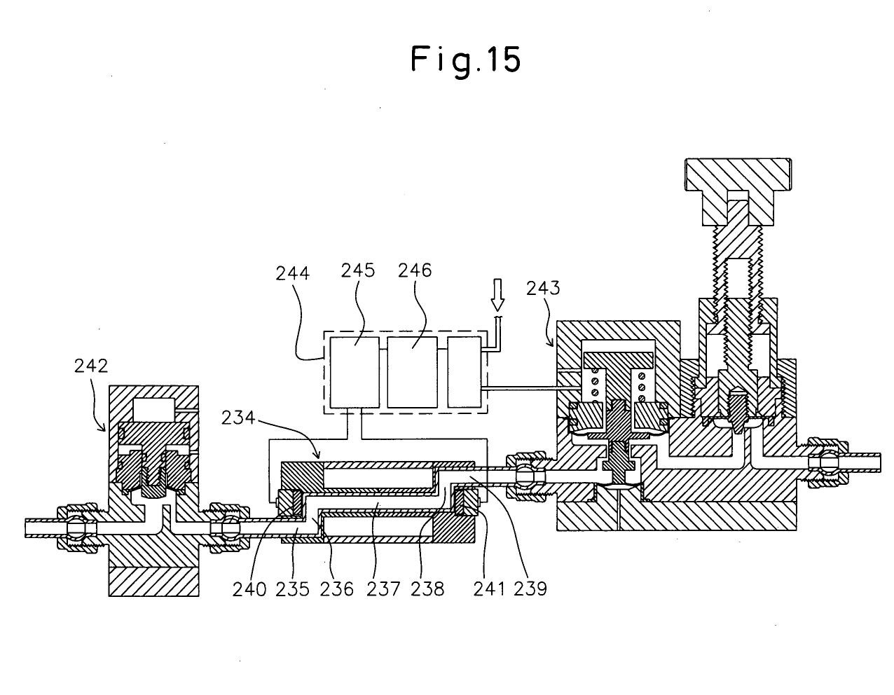

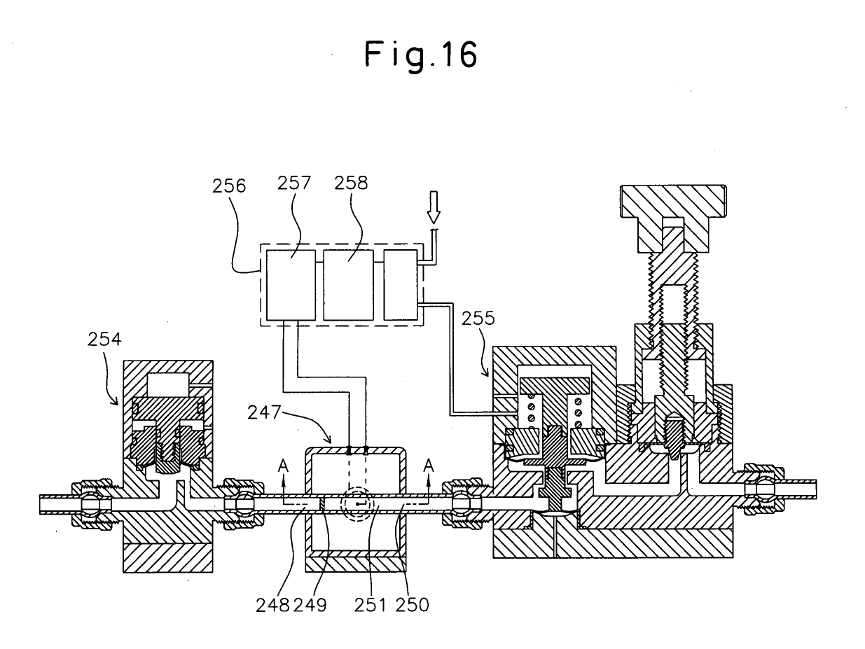

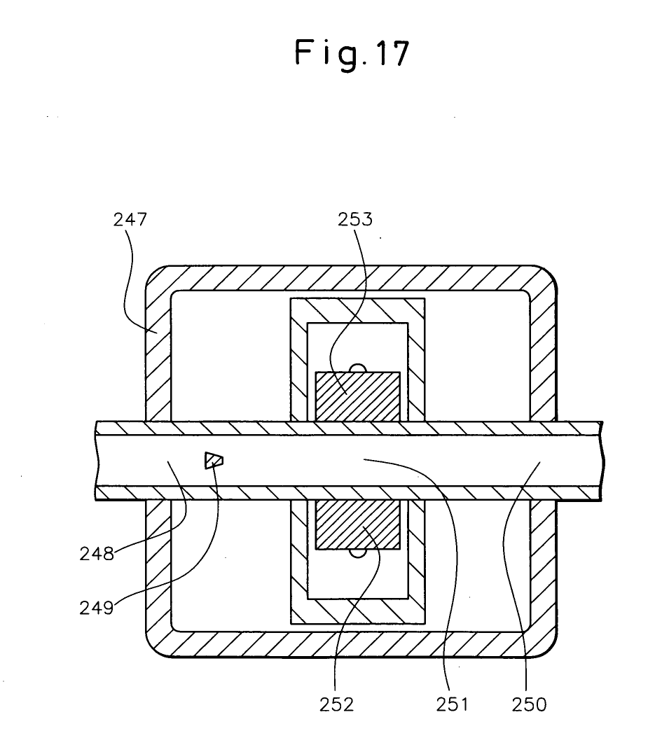

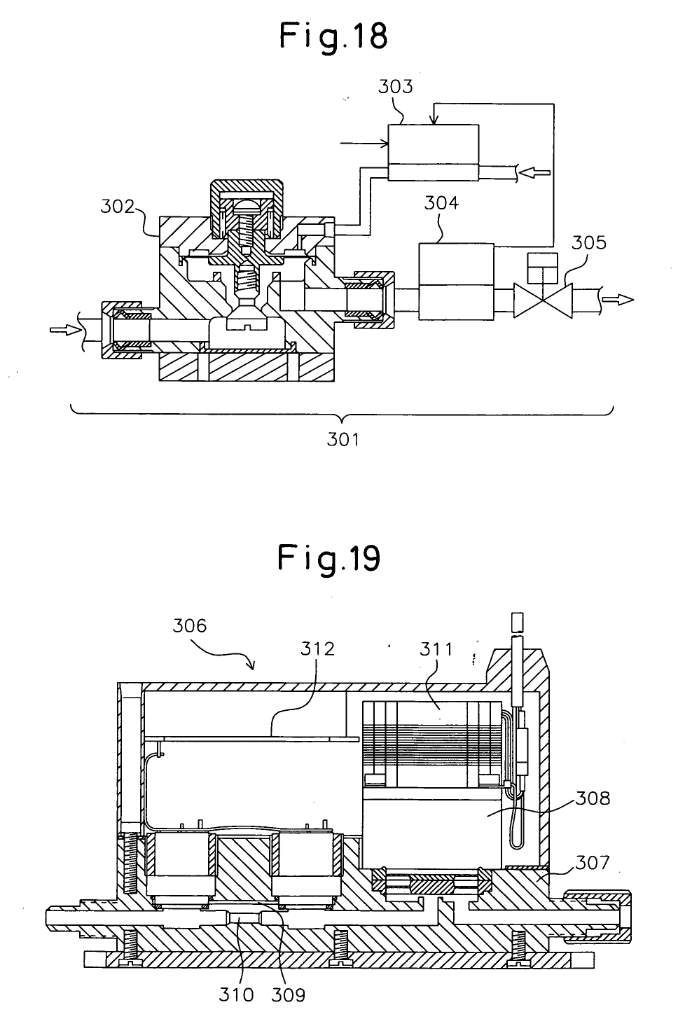

Below, the mode of carrying out the present invention will be explained with reference to the embodiments shown in the drawings, but the present invention is not limited to these embodiments of course. FIG. 1 is a vertical cross-sectional view of a fluid control system showing a first embodiment of the present invention. FIG. 2 is an enlarged view of a fluid control valve of FIG. 1. FIG. 3 is a vertical cross-sectional view of a fluid control system showing a second embodiment of the present invention. FIG. 4 is an enlarged view of a shutoff valve of FIG. 2. FIG. 5 is a vertical cross-sectional view of a fluid control system showing a third embodiment of the present invention. FIG. 6 is an enlarged view of a throttle valve of FIG. 5. FIG. 7 is an enlarged view of principal parts showing the throttle valve of FIG. 6 in the open state. FIG. 8 is an enlarged view of principal parts showing the throttle valve of FIG. 6 in the closed state. FIG. 9 is an enlarged view of principal parts showing the throttle valve of FIG. 6 in the semi-open state. FIG. 10 is a vertical cross-sectional view of a fluid control system showing a fourth embodiment of the present invention. FIG. 11 is a vertical cross-sectional view of a fluid control system showing a fifth embodiment of the present invention. FIG. 12 is a vertical cross-sectional view of a fluid control system showing a sixth embodiment of the present invention. FIG. 13 is an enlarged view of a fluid control valve of FIG. 12. FIG. 14 is the same view as FIG. 13 adding another display to FIG. 13. FIG. 15 is a vertical cross-sectional view of a fluid control system showing a seventh embodiment of the present invention. FIG. 16 is a vertical cross-sectional view of a fluid control system showing an eighth embodiment of the present invention. FIG. 17 is a cross-sectional view along the line A-A of FIG. 16.

### First Embodiment

Below, a fluid control system of a first embodiment of the present invention will be explained with reference to FIG. 1 and FIG. 2.

1 is a fluid control system installed in a semiconductor production facility performing an etching process in the production of semiconductors. The fluid control system 1 is formed from a fluid inflow port 2, flow rate measuring device 3, fluid control valve 4, fluid outflow port 5, and control part 6. These are configured as follows:

2 is a PFA fluid inflow port. The fluid inflow port 2 is communicated with an inlet passage 7 of the later-mentioned flow rate measuring device 3.

3 is a flow rate measuring device for measuring the flow rate of a fluid. The flow rate measuring device 3 has an inlet passage 7, a straight passage 8 provided vertical from the inlet passage 7, and an outlet passage 9 provided vertical from the straight passage 8 and provided in parallel to the inlet passage 7 in the same direction. Ultrasonic oscillators 10 and 11 are arranged facing each other at positions where the side walls of the inlet and outlet passages 7 and 9 intersect the axis of the straight passage 8. The outlet passage 9 is communicated with the inlet passage 22 of the later explained fluid control valve 4. The ultrasonic oscillators 10 and 11 are covered by a fluororesin, while the wires extending from said oscillators 10, 11 are connected to a later explained processor 54 of the control part 6. Note that everything other than the ultrasonic oscillators 10 and 11 of the flow rate measuring device 3 are made of PFA. Further, the inlet passage 7 and the fluid inflow port 2 are directly connected through a connection member 57 changed in direction in the passage, while the outlet passage 9 and the inlet passage 22 of the later mentioned fluid control valve 4 are directly connected and communicated through a connection member 58 changed in direction in the passage.

4 is a fluid control valve controlling the fluid pressure in accordance with the operating pressure. The fluid control valve 4 is formed from a main body 12, bonnet 13, spring receiver 14, piston 15, spring 16, first valve mechanism 17, second valve mechanism 18, and baseplate 19.

12 is a PTFE main body. This has a second cavity 20 provided at a center of a bottom part and opening at a base part and a first cavity 21 provided at a top part with a top face open and having a diameter larger than a diameter of the second cavity 20. It is provided at its side face with an inlet passage 22 communicating with the second cavity 20, at the face facing the inlet passage 22 with an outlet passage 23 communicating with the first cavity 21, and further a communicating hole 24 communicating the first cavity 21 and second cavity 20 and having a diameter smaller than the diameter of the first cavity 21. The top face part of the second cavity 20 is made a valve seat 25. Further, the outlet passage 23 is communicated with a later mentioned fluid outflow port 5.

13 is a PVDF bonnet. This is provided inside it with a cylindrical cavity 26 and with a step part 27 enlarged in diameter over the cavity 26 at the inner circumference of a bottom end and is provided at its side face with an air feed hole 28 communicating the cavity 26 and the outside for supplying the inside of the cavity 26 with compressed air and a fine exhaust hole 29 for exhausting fine amounts of compressed air introduced from the air feed hole 28. Note that the exhaust hole 29 need not be provided when not required for the supply of compressed air.

14 is a PVDF flat circular shaped spring retainer. It has a through hole 30 at its center. The approximate top half is inserted into the step part 27 of the bonnet 13. At the side face of the spring retainer 14, a ring-shaped groove 31 is provided. By fitting an O-ring 32 into it, outflow of compressed air from the bonnet 13 to the outside is prevented.

15 is a PVDF piston. This has at its top part a disk-shaped flange 33, a piston shaft 34 provided sticking out from the bottom part of the center of the flange 33 in a columnar shape, and a first connecting part 35 comprised of a female thread part provided at the bottom end of the piston shaft 34. The piston shaft 34 is provided in a smaller diameter than the through hole 30 of the spring retainer 14, while the first connecting part 35 is connected with a second connecting part 40 of the later explained first valve mechanism 17 by screwing.

16 is a SUS spring. This is gripped between the bottom end face of the flange 33 of the piston 15 and the top end face of the spring retainer 14. Along with vertical motion of the piston 15, the spring 16 also expands and contracts. So that the change in load at that time becomes small, one with a long free length is preferably used.

17 is a PTFE first valve mechanism. This has a first diaphragm 38 having a film part 37 having a tubular part 36 provided sticking out upward from its outer peripheral edge and having a thick part at its center, a second connecting part 40 comprised of a small diameter male thread provided at a top end of a shaft 39 provided sticking out from the top face of the center of the first diaphragm 38, and a third connecting part 41 provided sticking out from the bottom face of the center, comprised of a female thread part formed at the bottom end, and screwed with a fourth connecting part 45 of the later explained second valve mechanism 18. The tubular part 36 of the first diaphragm 38 is fastened by being gripped between the main body 12 and the spring retainer 14, so the first valve chamber 42 formed by the bottom face of the first diaphragm 38 is formed sealed tight. Further, the top face of the first diaphragm 38 and the cavity 26 of the bonnet 13 are sealed tight through the O-ring 32 and form an air chamber filled with compressed air supplied from the air feed hole 28 of the bonnet 13.

18 is a PTFE second valve mechanism. It is configured from a valve element 43 arranged inside the second cavity 20 of the main body 12 and provided in a larger diameter than the communicating hole 24, a shaft 44 provided sticking out from the top end face of the valve element 43, a fourth connecting part 45 provided at its top end and comprised of a male thread part fastened by connection by screwing with the third connecting part 41, a rod 46 provided sticking out from the bottom end face of the valve element 43, and second diaphragm 48 provided extending from the bottom end face of the rod 46 in the radial direction and having a tubular projection 47 provided sticking out downward from its peripheral edge. The tubular projection 47 of the second diaphragm 48 is gripped between a projection 50 of the later explained baseplate 19 and the main body 12, whereby a second valve chamber 49 formed between the second cavity 20 of the main body 12 and the second diaphragm 48 is sealed tight.

19 is a PVDF baseplate. This has a projection 50 fastening the tubular projection 47 of the second diaphragm 48 of the second valve mechanism 18 by gripping it with the main body 12 at the center of its top part, is provided with a cut recess 51 at the top end of the projection 50, and is provided with a breathing hole 52 communicating with the cut recess 51 at its side face. It is fastened gripping the main body 12 with the bonnet 13 by bolts and nuts (not shown). Note that in this embodiment, the spring 16 is configured provided inside the cavity 26 of the bonnet 13 to bias the piston 15, first valve mechanism 17, and second valve mechanism 18 upward, but the spring 16 may also be configured provided in the cut recess 51 of the baseplate 19 to bias the piston 15, first valve mechanism 17, and second valve mechanism 18 upward.

5 is a PFA fluid outflow port.

6 is a control part. The control part 6 has a processor 54 calculating the flow rate from the signal output from said flow rate measuring device 3 and a control part 55 performing feedback control. The processor 54 is provided with a transmission circuit outputting ultrasonic vibration of a certain period to a transmitting side ultrasonic oscillator 10, a reception circuit receiving ultrasonic vibration from a receiving side ultrasonic oscillator 11, a comparison circuit comparing propagation times of the ultrasonic vibrations, and a processing circuit for calculating a flow rate from a difference of the propagation times output from the comparison circuit. The control part 55 has a control circuit for controlling the operating pressure of the later explained electropneumatic converter 56 so as to become the flow rate set with respect to the flow rate output from the processor 54. Note that in this embodiment, the control part 6 is configured provided separately from the fluid control system 1 for central control in another location, but may also be provided integrally with the fluid control system 1.

56 is an electropneumatic converter for adjusting the operating pressure of the compressed air. The electropneumatic converter 56 is configured from a solenoid valve electrically driven for proportionally adjusting the operating pressure and adjusts the operating pressure of the fluid control valve 4 in accordance with the control signal from said control part 6.

Next, the operation of the fluid control system of the first embodiment of the present invention will be explained.

The fluid flowing into the fluid inflow port 2 of the fluid control system 1 flows into the first flow rate measuring device 3 and is measured for the flow rate in the straight passage 8. Ultrasonic vibration is propagated from the ultrasonic oscillator 10 positioned at the upstream side in the flow of the fluid to the ultrasonic oscillator 11 positioned at the downstream side. The ultrasonic vibration received by the ultrasonic oscillator 11 is converted to an electrical signal and output to the processor 54 of the control part 6. When ultrasonic vibration is propagated from the upstream side ultrasonic oscillator 10 and received by the downstream side ultrasonic oscillator 11, the processor 54 instantaneously switches transmission and reception so that ultrasonic vibration is propagated from the ultrasonic oscillator 11 positioned at the downstream side to the ultrasonic oscillator 10 positioned at the upstream side. The ultrasonic vibration received by the ultrasonic oscillator 10 is converted to an electrical signal and output to the processor 54 in the control part 6. At this time, the ultrasonic vibration is propagated against the flow of the fluid in the straight passage 8, so compared to when the ultrasonic vibration is propagated from the upstream side to the downstream side, the propagation speed of the ultrasonic vibration in the fluid is slower and the propagation time becomes longer. The output mutual electrical signals are measured for propagation times in the processor 54 and the flow rate is calculated from the difference of the propagation times. The flow rate calculated by the processor 54 is converted to an electrical signal and output to the control part 55.

Next, the fluid passing through the flow rate measuring device 3 flows into the fluid control valve 4. The control part 55 of the control part 6 outputs a signal to the electropneumatic converter 56 so that the difference between a freely set flow rate and flow rate measured in real time becomes zero. The electropneumatic converter 56 supplies an operating pressure according to that to the fluid control valve 4 to drive it. The flow rate of the fluid flowing out from the fluid control valve 4 is determined by the relationship between the pressure adjusted by the fluid control valve 4 and the pressure loss after the fluid control valve 4. The higher the adjusted pressure, the larger the flow rate, while conversely the lower the pressure, the smaller the flow rate. For this reason, the fluid is controlled by the fluid control valve 4 so that the flow rate becomes a constant value based on a set flow rate, that is, so that the difference between the set flow rate and the measured flow rate converges to zero.

Here, the operation of the fluid control valve 4 with respect to the operating pressure supplied from the electropneumatic converter 56 will be explained (see FIG. 2). The valve element 43 of the second valve mechanism 18 is acted on by a force biasing it upward by the springback force of the spring 16 gripped between the flange 33 of the piston 15 and the spring retainer 14 and the fluid pressure at the bottom face of the first diaphragm 38 of the first valve mechanism 17 is acted upon by a force biasing it downward by the pressure of the operating pressure at the top face of the first diaphragm 38. More strictly speaking, the bottom face of the valve element 43 and the top face of the second diaphragm 48 of the second valve mechanism 18 receive the fluid pressure, but these pressure receiving areas are considered substantially equivalent, so the forces are substantially cancelled out. Therefore, the valve element 43 of the second valve mechanism 18 stops at a position where the above three forces balance out.

If increasing the operating pressure supplied from the electropneumatic converter 56, the force pushing down the first diaphragm 38 increases, whereby the opening area of the fluid control part 53 formed between the valve element 43 and valve seat 25 of the second valve mechanism 18 increases, so it is possible to increase the pressure of the first valve chamber 42. Conversely, if reducing the operating pressure, the opening area of the fluid control part 53 falls and the pressure falls. For this reason, it is possible to adjust the operating pressure to set any pressure.

If the upstream side fluid pressure increases in this state, instantaneously the pressure inside the first valve chamber 42 also increases. This being the case, compared with the force received by the top face of the first diaphragm 38 from the compressed air due to the operating pressure, the force received by the bottom face of the first diaphragm 38 becomes larger and the first diaphragm 38 moves upward. Along with this, the position of the valve element 43 also moves upward, so the opening area of the fluid control part 53 formed with the valve seat 25 is reduced and the pressure inside the first valve chamber 42 is reduced. Finally, the valve element 43 moves to the position where the above three forces balance out and stops. At this time, if the load of the spring 16 does not greatly change, the pressure inside the cavity 26, that is, the force received by the top face of the first diaphragm 38, will be constant, so the pressure received by the bottom face of the first diaphragm 38 will become substantially constant. Therefore, the fluid pressure of the bottom face of the first diaphragm 38, that is, the pressure inside the first valve chamber 42, becomes substantially the same as the pressure before the increase in upstream side pressure.

When the upstream side fluid pressure falls, instantaneously the pressure inside the first valve chamber 42 also falls. This being the case, compared with the force received by the top face of the first diaphragm 38 from the compressed air due to the operating pressure, the force received by the bottom face of first diaphragm 38 from the fluid becomes smaller, so the first diaphragm 38 moves downward. Along with this, the position of the valve element 43 also moves downward, so the opening area of the fluid control part 53 formed with the valve seat 25 increases and the fluid pressure of the first valve chamber 42 is increased. Finally, the valve element 43 moves to a position where the above three forces balance out and stops. Therefore, in the same way as an increase in the upstream side pressure, the fluid pressure inside the first valve chamber 42 becomes substantially the same as the original pressure.

Due to the above operation, the fluid flowing into the fluid control system 1 is controlled to a fluid pressure set by feedback control by the flow rate measuring device 3, fluid control valve 4, and control part 6. By becoming a constant fluid pressure, the fluid flow rate also becomes constant and the fluid flows out from the fluid outflow port 5 controlled in flow rate. The flow rate measuring device 3, that is, the ultrasonic flowmeter, measures the flow rate from the difference in propagation time with respect to the direction of flow of the fluid, so can accurately measure even a fine flow rate. Further, the fluid control valve 4, being configured as explained above, is compact and enables stable fluid pressure control, so exhibits a superior effect in fine flow rate fluid control. Further, even if the upstream side pressure of the fluid flowing into the fluid control system 1 fluctuates, due to the operation of the fluid control valve 4, the flow rate is autonomously held constant, so even if pump pulsation or other instantaneous pressure fluctuations occur, the flow rate can be controlled to be stable.

### Second Embodiment

Next, a fluid control system of a second embodiment of the present invention will be explained with reference to FIG. 3 and FIG. 4.

59 is a fluid control system. The fluid control system 59 is formed from a fluid inflow port 60, shutoff valve 61, flow rate measuring device 62, fluid control valve 63, fluid outflow port 64, and control part 65. These parts are configured as follows:

61 is a shutoff valve. The shutoff valve 61 is formed from a main body 66, a drive unit 67, a piston 68, a diaphragm holder 69, and a valve element 70.

66 is a PTFE main body. It has a valve chamber 71 at the center of the top end in the axial direction and an inlet passage 72 and outlet passage 73 communicating with the valve chamber 71. The inlet passage 72 communicates with the fluid inflow port 60, while the outlet passage 73 communicates with the flow rate measuring device 62. Further, at the outer side of the valve chamber 71 at the top face of the main body 66, a ring-shaped groove 74 is provided.

67 is a PVDF drive part. This is provided inside it with a cylindrical cylinder part 75 and is fastened to the top of said main body 66 by bolts and nuts (not shown). At the side face of the drive part 67, a pair of operating fluid feed ports 76 and 77 communicated with the top side and bottom side of the cylinder part 75 are provided.

68 is a PVDF piston. This is inserted into the cylinder part 75 of the drive part 67 in a sealed state and able to move vertically in the axial direction and is provided at the center of its bottom face with a rod part 78 vertically down.

69 is a PVDF diaphragm holder. It has a through hole 79 through which the rod part 78 of the piston 68 passes at its center part and is gripped between the main body 66 and the drive part 67.

70 is a PTFE valve element housed in a valve chamber 71. It passes through the through hole 79 of the diaphragm holder 69, is screwed with the front end of the rod part 78 of the piston 68 sticking out from the bottom face of the diaphragm holder 69, and moves up and down in the axial direction along with vertical motion of the piston 68. The valve element 70 has a diaphragm 80 at its outer circumference. The outer circumferential edge of the diaphragm 80 is inserted into the ring-shaped groove 74 of the main body 66 and is clamped between the diaphragm holder 69 and the main body 66. The rest of the configuration of the second embodiment is similar to that of the first embodiment, so the explanation will be omitted.

Next, the operation of the fluid control system of the second embodiment of the present invention will be explained.

The fluid flowing into the fluid inflow port 60 of the fluid control system 59 flows into the first shutoff valve 61. When the shutoff valve 61 is closed, the fluid is cut off by the shutoff valve 61 and the fluid no longer flows downstream from the shutoff valve 61. Due to this, the flow rate measuring device 62, fluid control valve 63, and control part 64 in the fluid control system 59 can be easily maintained etc. Further, when some sort of trouble occurs in the passage, the shutoff valve 61 can be closed to cut off the fluid on an emergency basis, so it is possible to prevent secondary damage such as corrosive fluid leaking out and corroding the parts in the semiconductor production facility.

Further, when the shutoff valve 61 is closed, the fluid passes through the shutoff valve 61, flows into the flow rate measuring device 62, is feedback controlled by the flow rate measuring device 62, fluid control valve 63, and control part 65 to be controlled so as to become a set flow rate, and flows out from the fluid outflow port 64.

Here, the operation of the shutoff valve 61 will be explained. If compressed air is injected from the outside from a working fluid feed port 77, the pressure of the compressed air pushes up a piston 68, so a rod 78 connected to this is lifted upward, a valve element 70 connected to the bottom end of the rod 78 is also lifted upward, and the valve opens.

On the other hand, if compressed air is injected from the working fluid feed port 76, the piston 68 is pushed down. Along with this, the rod 78 and the valve element 70 connected to its bottom end are also pushed downward and the valve closes.

Due to the above operation, the fluid flowing into the fluid inflow port 60 of the fluid control system 59 is cut off by closing the shutoff valve 61, whereby the maintenance etc. of the fluid control system 59 can be easily performed and the fluid can be cut off on an emergency basis. The rest of the operation of the second embodiment is similar to that of the first embodiment, so an explanation will be omitted.

### Third Embodiment

Next, a fluid control system of a third embodiment of the present invention will be explained with reference to FIG. 5 to FIG. 9.

81 is a fluid control system. The fluid control system 81 is formed from a fluid inflow port 82, flow rate measuring device 83, fluid control valve 84, throttle valve 85, fluid outflow port 86, and control part 87. These are configured as follows:

85 is a throttle valve with an adjustable opening area. The throttle valve 85 is formed from a main body 88, diaphragm 97, second stem 106, diaphragm holder 108, first stem 114, first stem support member 121, and bonnet 125.

88 is a PTFE main body. At the top of the main body 88, it has a substantially dish-shaped valve chamber 90 formed with a later explained diaphragm 97. At the bottom face of the valve chamber 90, a valve seat face 89 fully closing and sealing the passage by being pressed against by a later explained second valve element 99 is formed. This also has an inlet passage 92 communicating with a communicating port 91 provided at the center of the valve seat face 89 and an outlet passage 93 communicating with the valve chamber 90. Above the valve chamber 90, a recess 95 for receiving an engagement part 110 of a later explained diaphragm holder 108 is provided. At its bottom face, a ring-shaped recess 94 with which a ring-shaped locking part 101 of a later explained diaphragm 97 engages is provided. Further, at the outer circumference of the top of the main body 88, a male thread part 96 with which the later explained bonnet 125 is screwed is provided. Note that in the present embodiment, the main body 88 of the throttle valve 85 is provided on the same base block as the main body of the fluid control valve 84.

97 is a PTFE diaphragm. It is integrally provided with a first valve element 98 provided vertically from the center of the liquid contacting surface at the bottom of the diaphragm 97, a second valve element 99 comprising a ring-shaped projection formed at a position away from the first valve element 98 in the radial direction and with a front end of an arc-shaped cross-section, a thin film part 100 formed continuing from the second valve element 99 in the radial direction, a ring-shaped locking part 101 of a rectangular cross-section at the outer circumference of the thin film part 100, and a connecting part 103 connected to the bottom end of a later explained second stem 106 at the top part of the diaphragm 97. The first valve element 98 is provided with a straight part 104 descending downward and a taper part 105 continuing from the same. Between the first valve element 98 and the second valve element 99, a ring-shaped groove 102 is formed. To suppress the flow of fluid in the space of the ring-shaped groove 102, the volume of the space formed between the ring-shaped groove 102 and the valve seat face 89 at the time of full closure is set to two times or more the volume of the space formed by the straight part 104 of the first valve element 98 and the communicating port 91 at the time of full closure. Further, the outside diameter D₁ of the straight part 104 of the first valve element 98 is set to 0.97 D with respect to the inside diameter D of the communicating port 91, the taper angle of the taper part 105 of the first valve element 98 is set to 15° with respect to the axis, and the diameter D₂ of the ring-shaped projection of the second valve element 99 is set to 1.5 D with respect to the inside diameter D of the communicating port 91. The diaphragm 97 is fastened by being gripped between the main body 88 and the later explained diaphragm holder 108 in the state with the ring-shaped locking part 101 engaged with the ring-shaped recess 94 of the main body 88.

106 is a PP second stem. The outer circumference of the top end of the second stem 106 is provided with a male thread part 107 to be screwed into a female thread part 115 of the later explained first stem 114. The outer circumference of the bottom is formed into a hexagonal shape. The bottom end is connected to the connecting part of the diaphragm 97 by screwing.

108 is a PP diaphragm holder. At the top of the diaphragm holder 108, an insertion part 109 with a hexagonal shaped outer circumference is provided, while at the bottom, an engagement part 110 with a hexagonal shaped outer circumference is provided. At the outer circumference of the center, a flange 111 is provided. At the inner circumference of the diaphragm holder 108, a hexagonal shaped through hole 112 is provided. From the bottom end face, a taper part 113 tapering toward the through hole 112 is provided. The insertion part 109 is engaged with a hollow part 123 of a later explained first stem support member 121 in a non-rotatable manner, while the engagement part 110 is engaged with the recess 95 of the main body 88 in a non-rotatable manner. The second stem 106 is inserted through the through hole 112 so that the second stem 106 is supported to be able to move vertically but not to rotate.

114 is a PP first stem. At the inner circumference of the bottom part of the first stem 114, a female thread part 115 with a pitch of 1.25 mm with which the male thread part 107 of the second stem 106 screws is provided, while at the outer circumference, a male thread part 116 with a pitch of 1.5 mm is provided. The pitch difference between the male thread part 116 and the female thread part 115 is 0.25 mm or formed to become ⅙ of the pitch of the male thread part 116. At the outer circumference of the bottom part of the first stem 114, a stopper part 117 provided sticking out in the radial direction is provided. At a projection 118 at the top part, a handle 119 having a later explained grip part 120 is fastened.

121 is a PP first stem support member. At the inner circumference of the top part of the first stem support member 121, a female thread part 122 to be screwed with the male thread part 116 of the first stem 114 is provided, at the inner circumference of the bottom part, a hexagonal shaped hollow part 123 for engagement with the insertion part 109 of the later explained diaphragm holder 108 in a non-rotatable manner is provided, and at the outer circumference of the bottom part, a flange 124 fastened by a later explained bonnet 125 is provided.

125 is a PP bonnet. At the top part of the bonnet 125, a locking part 126 having an inside diameter smaller than the outside diameter of the flange 124 of the first stem support member 121 is provided, while at the inner circumference of the bottom part, a female thread part 127 to be screwed with the male thread part 96 of the main body 88 is provided. The bonnet 125 can be screwed with the main body 88 in the state with the flange 124 of the first stem support member 121 and the flange 111 of the diaphragm holder 108 gripped between the locking part 126 and the main body 88 so as to fasten the parts. The rest of the configuration of the third embodiment is similar to that of the first embodiment, so the explanation will be omitted.

Next, the operation of the fluid control system of the third embodiment of the present invention will be explained.

The fluid flowing into the fluid inflow port 82 of the fluid control system 81 and running through the flow rate measuring device 83 and the fluid control valve 84 is controlled to a constant pressure by feedback control, then flows into the throttle valve 85. The fluid flowing into the throttle valve 85 flows out adjusted to a constant flow rate set by the throttle valve 85 by the finely adjusted opening area.

Here, the operation of the throttle valve 85 being adjusted finely in opening degree will be explained. First, in the fully closed state of the throttle valve 85 in the present embodiment (state of FIG. 8), the fluid flowing in from the inlet passage 92 is stopped by the second valve element 99 pressed against the valve seat face 89.

If the handle 119 is turned in the direction where the valve opens, along with the turning of the handle 119, the first stem 114 rises by exactly the amount of pitch of the male thread part 116 of the outer circumference, while conversely the second stem 106 screwed into the female thread part 115 of the inner circumference of the first stem 114 descends by exactly the amount of the pitch of the female thread part 115 of the first stem 114. However, the second stem 106 is housed in the through hole 112 of the diaphragm holder 108 in a non-rotatable state and can only move in the vertical direction, so the second stem 106 rises by the pitch difference between the male thread part 116 of the outer circumference of the first stem 114 and the female thread part 115 of the inner circumference with respect to the main body 88. In this embodiment, the pitch of the male thread part 116 of the first stem 114 is 1.5 mm, while the pitch of the female thread part 115 of the first stem 114 is 1.25 mm, so by turning the handle 119 interlocked with the first stem 114 by one turn, the second stem 106 rises by 0.25 mm (⅙ of pitch of male thread part 116). Along with this, the diaphragm 97 connected with the second stem 106 rises, whereby the second valve element 99 which had first been pressed against the valve seat face 89 of the main body 88 separates from the valve seat face 89, the first valve element 98 rises along with the rise of the diaphragm, and the throttle valve 85 becomes semiopen in state (state of FIG. 9). The fluid flows in from the inlet passage 92 to the valve chamber 90, passes through the outlet passage 93, and is discharged.

Next, if the handle 119 is further turned in the opening direction from the above semi-opened state of the throttle valve 85 (state of FIG. 9), the stopper part 117 of the outer circumference of the bottom part of the first stem 114 presses against a ceiling face 130 of the first stem support member 121 whereby the turning is stopped. Interlocked with the turning of the handle 119, first stem 114, and second stem 106, the diaphragm 97 rises. The first valve element 98 and the second valve element 99 rise along with the rise of the diaphragm 97 whereby the valve becomes fully opened (state of FIG. 6 and FIG. 7). Note that the first valve element 98 is not pulled out from the communicating port 91 even in the fully opened state, so the throttle valve 85 adjusts the flow rate from the fully closed to fully opened states.

In the above action, the opening area S1 of the first flow rate regulator 128 formed by the first valve element 98 and the communicating port 91 and the opening area S2 formed by the second valve element 99 and valve seat face 89 change according to the opening degree of the throttle valve 85 from fully closed to fully open, but the actions on adjusting the flow rate differ depending on the relative magnitude of S1 and S2. The relationship between S1 and S2 from fully closed to fully open of the opening degree of the throttle valve 85 and the mechanism of adjustment of the flow rate will be explained based on FIG. 7 to FIG. 9.

In the case of S1>S2, the opening degree of the throttle valve 85 is from fully closed to slightly open, and the flow rate is adjusted by the second flow rate regulator 129, that is, in accordance with the magnitude of S2. When S1>S2 in range, the first flow rate regulator 128 can adjust the flow rate to be constant by the straight part 104 of the first valve element 98 and the communicating port 91. The fluid is made constant in flow rate by the first flow rate regulator 128, then flows into the space part formed by the first ring-shaped groove 102 before reaching the second flow rate regulator 129. The fluid strikes the bottom face of the ring-shaped groove 102, spreads in the radial direction, strikes the inner circumference of the second valve element 99, changes in direction of flow and then reaches the second flow rate regulator 129, so the flow of the fluid is stopped once at the space part. For this reason, the fluid can be suppressed in flow at the space part and kept from rapidly increasing in flow rate, reaches the second flow rate regulator 129 by a flow able to be sufficiently controlled by the second flow rate regulator 129, and is adjusted in flow rate precisely by the second flow rate regulator 129, so the throttle valve 85 can finely adjust the flow rate at the time of slight opening. At this time, since the diameter D₂ of the ring-shaped projection of the second valve element 99 is set in the range of 1.1 D≦D₂≦2 D with respect to the inside diameter D of the communicating port 91, it is possible to form the ring-shaped groove 102 effective for suppressing the increase in flow rate between the first valve element 98 and the second valve element 99 and possible to suppress the flow of fluid from the first flow rate regulator 128 at the space part formed by the ring-shaped groove 102.

In the case of S1=S2, the opening area S1 of the first flow rate regulator 128 and the opening area S2 of the second flow rate regulator 129 become the same. At that point of time, the part adjusting the flow rate switches from the second flow rate regulator 129 to the first flow rate regulator 128. That is, the flow rate is adjusted by the magnitude of the S1.

In the case of S1<S2, this is from when the opening degree of the throttle valve 85 is made larger than slightly open to fully open. With the second flow rate regulator 129, fine adjustment of the flow rate is difficult, so the first flow rate regulator 128, that is, the magnitude of the S1, is used for adjustment. In the range of S1<S2, the first flow rate regulator 128 adjusts the flow rate by the taper part 105 of the first valve element 98 and the communicating port 91. The taper part 105 of the first valve element 98 is set so that the opening area S1 increases proportionally to the opening degree of the throttle valve 85, so it is possible to adjust the flow rate so as to increase linearly proportionally as the opening degree of the throttle valve 85 is made larger.

From this, the throttle valve 85 of the present invention adjusts the flow rate by the second flow rate regulator 129 when the opening degree is very small, while when enlarging the opening degree, switches from the second flow rate regulator 129 to the first flow rate regulator 128 for adjustment of the flow rate, so a proportional relationship of a good flow rate with respect to the opening degree can be obtained from fully closed to fully opened, reliable adjustment of the flow rate becomes possible from a very small flow rate to a large flow rate, and the flow rate can be adjusted over a broad flow rate range.

Next, when the handle 119 is conversely made to turn in the closing direction from the fully opened state of the throttle valve 85, the valve element descends and the flow rate is adjusted in accordance with the opening degree of the throttle valve 85 by an operation reverse to the case of turning it in the opening direction. When making the handle 119 turn in the closing direction to fully close the valve, the second valve element 99 and the valve seat face 89 can be reliably completely closed and sealed by tangential contact. When the throttle valve 85 is fully closed, the first valve element 98 is always not in contact with the communicating port 91, so long term use of the throttle valve 85 will not lead to deformation due to wear of the valve element or valve seat face 89, and long term use resulting in the flow rate adjustment characteristics becoming unstable can be prevented.

Due to the above operation, the fluid flowing into the fluid inflow port 82 of the fluid control system 81 is feedback controlled by the flow rate measuring device 83, fluid control valve 84, and throttle valve 85 and the flow rate is finely adjusted, so is finely controlled to the set flow rate. Further, by changing the opening degree of the throttle valve 85, it is possible to control the flow rate over a broad flow rate range in the fluid control system 81. Furthermore, the throttle valve 85 is configured to be able to easily finely adjust the opening degree, so the opening degree can be finely adjusted precisely in a short time.

### Fourth Embodiment

Next, a fluid control system of a fourth embodiment of the present invention will be explained with reference to FIG. 10.

131 is a fluid control system. The fluid control system 131 is formed from a fluid inflow port 132, shutoff valve 133, flow rate measuring device 134, fluid control valve 135, throttle valve 136, fluid outflow port 137, and control part 138. The configuration and operation of the fourth embodiment are similar to the first embodiment to the third embodiment, so explanations will be omitted. In the fourth embodiment, feedback control is performed, the throttle valve 136 enables fine flow rate control over a broad flow rate range, the shutoff valve 133 enables maintenance etc. of the fluid control system 131 to be easily performed, and the fluid can be cut off on an emergency basis.

Here, in the first embodiment to the fourth embodiment, the adjoining valve and flow rate measuring device are directly connected without using any tubes or connecting pipes, so it is possible to make the fluid control system compact and reduce the space at the installation location. Further, the installation work becomes easy, the work time can be shortened, and the passage in the fluid control system can be shortened to the minimum necessary length, so the fluid resistance can be kept down.

### Fifth Embodiment

Next, a fluid control system of a fifth embodiment of the present invention will be explained with reference to FIG. 11.

139 is a fluid control system. The fluid control system 139 is formed from a fluid inflow port 140, a shutoff valve 141, a flow rate measuring device 142, a fluid control valve 143, a throttle valve 144, a fluid outflow port 145, and a control part 146. These are configured as follows:

147 is a base block of the fluid control system 139. The base block 147 is comprised of the main bodies of the shutoff valve 141, flow rate measuring device 142, fluid control valve 143, and throttle valve 144 formed into a single unit. As the main body of the shutoff valve 141, at the top part of the base block 147, a valve chamber 148 and an inlet passage 149 and outlet passage 150 communicated with the valve chamber 148 are formed. The inlet passage 149 is communicated with the fluid inflow port 140. As the flow rate measuring device 142, there are an inlet passage 151, a straight passage 152 provided vertically from the inlet passage 151, and an outlet passage 153 provided vertically from the straight passage 152 and in parallel to the outlet passage 151 in the same direction. At positions where the side walls of the inlet and outlet passages 151 and 153 intersect the axis of the straight passage 152, ultrasonic oscillators 154 and 155 are arranged facing each other. The inlet passage 151 is communicated with the outlet passage 150 of the shutoff valve 141. As the main body of the fluid control valve 143, there are a second cavity 156 opening at the base part at the bottom part of the base block 147 and a first cavity 157 provided at the top part opening at the top face and having a diameter larger than the diameter of the second cavity 156. This is provided with an inlet passage 158 communicating with the second cavity 156, an outlet passage 159 communicating with the first cavity 157 in a direction facing the inlet passage 158, and furthermore a communicating hole 160 communicating the first cavity 157 and second cavity 156 and having a diameter smaller than the diameter of the first cavity 157. The inlet passage 158 is communicated with the outlet passage 153 of the flow rate measuring device 142. As the main body of the throttle valve 144, there is a substantially dish shaped valve chamber 161 at the top part of the base block 147. At the bottom face of the valve chamber 161, a valve seat face 162 is formed. This has an inlet passage 164 communicating with a communicating port 163 provided at the center of the valve seat face 162 and an outlet passage 165 communicating with the valve chamber 161. Above the valve chamber 161, a recess 167 for receiving the diaphragm holder 166 is provided. At the bottom face of this, a ring-shaped recess 168 is provided. Further, the inlet passage 164 is communicated with the outlet passage 159 of the fluid control valve 143, while the outlet passage 165 is communicated with the fluid outflow port 145. The rest of the configuration of the fifth embodiment is similar to that of the fourth embodiment except that the main body is formed as a single unit, so the explanation will be omitted.

The operation of the fluid control system of the fifth embodiment of the present invention is similar to the fourth embodiment, so the explanation will be omitted. In the fifth embodiment, feedback control is performed, the throttle valve 144 enables fine flow rate control over a broad flow rate range, the shutoff valve 141 enables maintenance etc. of the fluid control system 139 to be easily performed, and the fluid can be cut off on an emergency basis.

Here, the fifth embodiment is configured with the valves and flow rate measuring device of the fluid control system of the fourth embodiment arranged in a single base block formed with a passage, but the valves and flow rate measuring devices of the fluid control systems of the first embodiment to third embodiment may also be configured arranged in single base blocks formed with passages. Operations similar to the above embodiment are performed. At this time, since the fluid control system is arranged in a single base block formed with a passage, the fluid control system can be made compact and the space at the installation location can be reduced. Further, the installation work becomes easy and the work time can be shortened, and the passage in the fluid control system can be shortened to the minimum required length, so the fluid resistance can be suppressed. Furthermore, the number of parts can be reduced, so assembly of the fluid control system can be facilitated.

### Sixth Embodiment

Next, a fluid control system using another fluid control valve of a sixth embodiment of the present invention will be explained with reference to FIG. 12 to FIG. 14.

169 is a fluid control valve. The fluid control valve 169 is formed by a main body part 170, a valve member 185, a first diaphragm part 186, a second diaphragm part 187, a third diaphragm part 188, and a fourth diaphragm part 189.

The main body part 170 has inside it a chamber 176 divided into a later explained first pressurization chamber 177, second valve chamber 178, first valve chamber 179, and second pressurization chamber 180, an inlet passage 194 for inflow of fluid from the outside to the chamber 176, and an outlet passage 201 for outflow of the fluid from the chamber 176 to a fluid outflow port 230. From the top, this is divided into the main body D174, main body C173, main body B172, main body A171, and main body E175. These are configured assembled together.

171 is a PTFE main body A positioned at the inside of the main body part 170. This is provided at its top part with a flat circular step part 190. At the center of the step part 190, an opening part 191 having a smaller diameter than the step part 190 and forming the bottom first valve chamber 183 is provided. Further, below the opening part 191, a flat circular bottom step part 192 with a larger diameter than the diameter of the opening part 191 is continuously provided. At the top face of the main body A171, that is, the peripheral edge of the step part 190, a ring-shaped groove 193 is provided. Further, from the side face, an inlet passage 194 communicating with the opening part 191 of the main body A171 is provided. The inlet passage 194 is communicated with the flow rate measuring device 231.

172 is a PTFE main body B fastened by being engaged with the top face of the main body A171. At the top part, a flat circular step part 195 is provided, while at the center of the step part 195, a hole part 196 forming a top second valve chamber 182 of a smaller diameter than the step part 195 is provided. Further, below the hole part 196, an opening part 197 with a diameter smaller than the diameter of the hole part 196 and a flat circular shape bottom step part 198 of the same diameter as the step part 190 of the main body A171 are continuously provided. The periphery of the bottom end of the opening part 197 forms a valve seat 199. At the bottom face of the main body B172, that is, the peripheral edge of the bottom step part 198, a ring-shaped groove 200 is provided at a position facing the ring-shaped groove 193 of the main body A171. Further, an outlet passage 201 positioned at the opposite side to the inlet passage 194 of the main body A171 and communicating with the hole part 196 from the side face of the main body B172 is provided. The outlet passage 201 is communicated with the fluid outflow port 230.

173 is a PTFE main body C fastened by being engaged with the top of the main body B172. At its center, it is provided with a flat circular shaped diaphragm chamber 202 passing through the top and bottom ends of the main body C173 and expanding in diameter at the top, a breathing hole 203 communicating the diaphragm chamber 202 and the outside, and a ring-shaped projection 204 to be engaged with the step part 195 of the main body B172 at its bottom end face centered around the diaphragm chamber 20.

174 is a PTFE main body D positioned at the top part of the main body C173. It is provided at its bottom with an air chamber 205 and at its center with an air feed hole 206 provided passing through the top face and introducing compressed air from the outside to the air chamber 205. Further, a fine exhaust hole 229 provided passing through the side face is also provided. Note that the exhaust hole 229 need not be provided if there is no need for it in the supply of compressed air.

175 is a PVDF main body E fastened by being engaged with the base part of the main body A171. At the center part, a hole part 207 opening at the top face and forming a second pressurization chamber 180 is provided. At the periphery of the top face of the hole part 207, a ring-shaped projection 208 fastened by being engaged with the bottom step part 192 of the main body A171 is provided. Further, at the side face of the main body E175, a small diameter breathing hole 209 communicating from there to the hole part 207 is provided.

The five main body A171, main body B172, main body C173, main body D174, and main body E175 configuring the main body part 170 explained above are fastened by bolts and nuts (not shown).

185 is a PTFE valve member. This has, and is formed integrally by, a first diaphragm part 186 having a thick part 210 provided in a flange shape at its center, a communicating hole 211 provided passing through the thick part 210, a circular shaped thin film part 212 provided extending from the outer circumference of the thick part 210 in the radial direction, and a ring-shaped rib 213 projecting out to the top and bottom at the outer peripheral edge of the thin film part 212, an inverted dish shaped valve element 214 provided at the center of the top part of the first diaphragm part 186, a top rod 215 provided sticking out upward from the top of the valve element 214 and having a top end formed into a substantially semispherical shape, and a bottom rod 216 provided sticking out downward from the center of the bottom end face of the thick part 210 and having a bottom end formed into a substantially semispherical shape. The ring shaped rib 213 provided at the outer peripheral edge of the first diaphragm part 186 is engaged with the two ring-shaped grooves 193 and 200 provided at the main body A171 and main body B172 and fastened by being gripped by the main body A171 and main body B172. Further, the space formed between the slanted face of the valve element 214 and the peripheral edge of the bottom end face of the opening part 197 of the main body B172 forms a fluid control part 217.

187 is a PTFE second diaphragm part. This has, and is formed integrally by a cylindrical thick part 218 at the center, a circular shaped thin film part 219 extending from the bottom end face of the thick part 218 in the radial direction, and a ring shaped seal part 220 provided at the outer peripheral edge of the thin film part 219. Further, the ring-shaped seal part 220 at the peripheral edge of the thin film part 219 is fastened by being gripped between the step part 195 at the top part of the main body B172 and the ring-shaped projection 204 of the main body C173. Note that the pressure receiving area of the second diaphragm part 187 has to be provided smaller than that of the first diaphragm part 186.

188 is a PTFE third diaphragm part. It is shaped the same as the second diaphragm part 187, but is arranged upside down from it. The top end face of the thick part 221 contacts the bottom rod 216 of the valve member 185. Further, the ring-shaped seal part 223 of the peripheral edge of the thin film part 222 is fastened by being gripped by the bottom step part 192 of the main body A171 and the ring-shaped projection 208 of the main body E175. Note that the pressure receiving area of the third diaphragm part 188 also has to be provided smaller than that of the first diaphragm part 186 in the same way as above.

189 is a fourth diaphragm part. This has a cylindrical rib 224 with an outside diameter approximately the same diameter as the diaphragm chamber 202 of the main body C173 at its peripheral edge, a columnar part 225 at its center, and a film part 226 provided connecting the inner periphery of the bottom end face of the cylindrical rib 224 and the outer periphery of the top end face of the columnar part 225. The cylindrical rib 224 is fastened by being engaged with the diaphragm chamber 202 of the main body C173 and is fastened by being gripped between the main body B172 and the main body C173. The columnar part 225 can move up and down freely in the diaphragm chamber 202. Further, at the bottom of the columnar part 225, the thick part 218 of the second diaphragm part 187 is engaged.

227 and 228 are a PVDF spring retainer and an SUS spring arranged at the hole part 207 of the main body E175. The two apply pressure pushing the third diaphragm part 188 inward (in the figure, upward).

Due to the above explained configurations, it is learned that the chamber 176 formed inside the main body part is divided into, from the top, a first pressurization chamber 177 formed from the fourth diaphragm part 189 and the air chamber 205 of the main body D174, a second valve chamber 178 comprised of both the bottom second valve chamber 181 formed between the first diaphragm part 186 and the bottom step part 198 of the main body B172 and the top second valve chamber 182 formed from the second diaphragm part 187 and the hole part 196 of the main body B172, a first valve chamber 179 comprised of a bottom first valve chamber 183 formed by the third diaphragm part 188 and the hole part 191 of the main body A171 and a top first valve chamber 184 formed by the first diaphragm part 186 and the step part 190 of the main body A171, and a second pressurization chamber 180 formed by the third diaphragm part 188 and the hole part 207 of the main body E175. The rest of the configuration of the sixth embodiment is similar to that of the second embodiment, so the explanation will be omitted.

Next, the operation of the fluid control system of the sixth embodiment of the present invention will be explained.

The fluid passing through the flow rate measuring device 231 flows into the fluid control valve 169. The control part 232 outputs a signal to the electropneumatic converter 233 so as to make the difference of the flow rate measured in real time from any set flow rate zero, whereby the electropneumatic converter 233 supplies a corresponding operating pressure to the fluid control valve 169 to drive it. The fluid flowing out from the fluid control valve 169 is controlled by the fluid control valve 169 so that the flow rate becomes a constant value at the set flow rate, that is, so that the difference between the set flow rate and the measured flow rate converges to zero.

Here, the operation of the fluid control valve 169 with respect to the operating pressure supplied from the electropneumatic converter 233 will be explained. The fluid flowing from the inlet passage 194 of the main body A171 of the fluid control valve 169 to the first valve chamber 179 passes through the communicating hole 211 of the valve member 185 whereby it is reduced in pressure and then flows into the bottom second valve chamber 181. Furthermore, when the fluid runs from the bottom second valve chamber 181 through the fluid control part 217 and flows into the top second valve chamber 182, it is again reduced in pressure due to the pressure loss at the fluid control part 217 and flows out from the outlet passage 201 to the fluid outflow port 230. Here, the diameter of the communicating hole 211 is set sufficiently small, so the flow rate of the fluid flowing through the valve is determined by the pressure difference before and after the communicating hole 211.

At this time, if looking at the forces received by the diaphragm parts 186, 187, and 188 from the fluid, the first diaphragm part 186 receives an upward direction force due to the difference in fluid pressures between the first valve chamber 179 and bottom second valve chamber 181, the second diaphragm part 187 receives an upward direction force due to the fluid pressure of the top second valve chamber 182, and the third diaphragm part 188 receives a downward direction force due to the fluid pressure in the first valve chamber 179. Here, the pressure receiving area of the first diaphragm part 186 is set sufficiently larger than the pressure receiving areas of the second diaphragm part 187 and third diaphragm part 188, so the forces acting on the second and third diaphragm parts 187 and 188 can be almost completely ignored compared with the force acting on the first diaphragm part 186. Therefore, the force received by the valve member 185 from the fluid becomes the upward direction force due to the difference in fluid pressures between the first valve chamber 179 and the bottom second valve chamber 181.

Further, the valve member 185 is biased downward by the pressuring means of the first pressurization chamber 177 and simultaneously biased upward by the pressurizing means of the second pressurization chamber 180. If adjusting the force of the pressurizing means of the first pressurization chamber 177 to be larger than the force of the pressurizing means of the second pressurization chamber 180, the composite force which the valve member 185 receives from the pressurizing means will become a downward direction force. Here, the “pressurizing means of the first pressurization chamber 177” is one using the operating pressure supplied from the electropneumatic converter 233, while the “pressurizing means of the second pressurization chamber 180” is one using the springback force of the spring 228.

Therefore, the valve member 185 stabilizes at the position where the downward direction composite force due to the different pressurizing means and the upward direction force due to the difference in fluid pressures between the first valve chamber 179 and the bottom second valve chamber 181 balance out. That is, the pressure of the bottom second valve chamber 181 is autonomously adjusted by the opening area of the fluid control part 217 so that the composite force of the different pressurizing means and the force due to the fluid pressure difference balance out. For this reason, the difference in fluid pressures between the first valve chamber 179 and the bottom second valve chamber 181 becomes constant and the pressure difference before and after the communicating hole 211 is held constant, whereby the flow rate of the fluid flowing through the valve is held constant at all times.

Here, the fluid control valve 169 operates by the composite force of the pressurizing means acting on the valve member 185 and the force due to the pressure difference between the first valve chamber 179 and the bottom second valve chamber 181 balance, so if adjusting and changing the composite force of the pressurizing means acting on the valve member 185, the difference in fluid pressures between the first valve chamber 179 and the bottom second valve chamber 181 will become a corresponding value. That is, by adjusting the downward direction force due to the pressurizing means of the first pressurization chamber, that is, the operating pressure supplied from the electropneumatic converter 233, the pressure difference before and after the communicating hole 211 can be changed and adjusted, so the flow rate can be set to any rate without disassembling the valve.

Further, if adjusting the force due to the pressurizing means of the first pressurization chamber 177 to become smaller than the force due to the pressurizing means of the second pressurization chamber 180, the composite force acting on the valve member 185 will become only the upward direction, so the valve element 214 of the valve member 185 will press against the valve seat 199 of the opening part 197 of the main body B172, and the fluid can be cut off. That is, if not adjusting the electropneumatic converter 233 to apply an operating pressure, the fluid control valve 169 becomes closed.

Due to the above operation, the fluid flowing into the fluid control system flows out at the fluid outflow port 230 controlled to become constant at a set flow rate by the fluid control valve 169. Furthermore, even if the upstream side pressure or the downstream side pressure of the fluid flowing into the fluid control system fluctuates, due to the operation of the fluid control valve 169, the flow rate is autonomously maintained constant, so even if pump pulsation or other instantaneous pressure fluctuations occur, the flow rate can be controlled stably. Further, the fluid control valve 169 is configured not to be affected by fluctuations in the back pressure, so can be preferably used for applications where the back pressure fluctuates. Further, by adjustment of the operating pressure, the fluid control valve 169 can be used as a shutoff valve, so it is not necessary to connect a separate valve to cut off the fluid. The rest of the operation of the sixth embodiment is similar to that of the second embodiment, so the explanation will be omitted.

### Seventh Embodiment

Next, a fluid control system in the case where the flow rate measuring device is another ultrasonic flowmeter according to a seventh embodiment of the present invention will be explained with reference to FIG. 15.

234 is a flow rate measuring device measuring the flow rate of a fluid. The flow rate measuring device 234 has an inlet passage 235, a first rising passage 236 provided vertically from the inlet passage 235, a straight passage 237 communicated with the first rising passage 236 and provided substantially parallel with the axis of the inlet passage 235, a second rising passage 238 provided vertically from the straight passage 237, and an outlet passage 239 communicating with the second rising passage 238 and provided substantially parallel with the axis of the inlet passage 235. At positions where the side walls of the first and second rising passages 236 and 238 intersect the axis of the straight passage 237, ultrasonic oscillators 240 and 241 are arranged facing each other. The ultrasonic oscillators 240 and 241 are covered by a fluororesin. Wires extending from said oscillators 240 and 241 are connected to a processor 245 of the later mentioned control part 244. Note that the parts other than the ultrasonic oscillators 240 and 241 of the flow rate measuring device 234 are made of PFA. The inlet passage 235 is communicated with the shutoff valve 242, while the outlet passage 239 is communicated with the fluid control valve 243. The rest of the configuration of the seventh embodiment is similar to that of the fourth embodiment, so the explanation will be omitted.

Next, the operation of the fluid control system of the seventh embodiment of the present invention will be explained.

The fluid flowing into the fluid control system passes through the shutoff valve 242 and flows into the flow rate measuring device 234. The fluid flowing into the flow rate measuring device 234 is measured for flow rate in the straight passage 237. The ultrasonic vibration is propagated from the ultrasonic oscillator 240 positioned at the upstream side in the flow of the fluid toward the ultrasonic oscillator 241 positioned at the downstream side. The ultrasonic vibration received at the ultrasonic oscillator 241 is converted to an electrical signal and output to the processor 245 of the control part 244. When the ultrasonic vibration is propagated from the upstream side ultrasonic oscillator 240 and received by the downstream side ultrasonic oscillator 241, the processor 245 instantaneously switches transmission and reception so that ultrasonic vibration is propagated from the ultrasonic oscillator 241 positioned at the downstream side to the ultrasonic oscillator 240 positioned at the upstream side. The ultrasonic vibration received by the ultrasonic oscillator 240 is converted into an electrical signal and output to the processor 245 in the control part 244. At this time, the ultrasonic vibration is propagated against the flow of the fluid in the straight passage 237, so compared with when the ultrasonic vibration is propagated from the upstream side to the downstream side, the speed of propagation of the ultrasonic vibration in the fluid is slower and the propagation time becomes longer. The output electrical signals are used to measure the propagation times in the processor 245 and the flow rate is calculated from the difference in propagation times. The flow rate calculated by the processor 245 is converted to an electrical signal which is then output to the control part 246. The rest of the operation of the seventh embodiment is similar to that of the fourth embodiment, so an explanation will be omitted.

### Eighth Embodiment

Next, a fluid control system for the case where the flow rate measuring device is an ultrasonic type vortex flowmeter according to an eighth embodiment will be explained with reference to FIG. 16 and FIG. 17.

247 is a flow rate measuring device. The flow rate measuring device 247 has straight passage 251 provided with an inlet passage 248, a vortex generator 249 provided vertically in the inlet passage 248 and generating a Karman vortex, and an outlet passage 250. At the side walls of the straight passage 251 downstream of the vortex generator 249, ultrasonic oscillators 252 and 253 are arranged facing each other at positions perpendicular to the passage axial direction. The ultrasonic oscillators 252 and 253 are covered by a fluororesin. The wires extending from said oscillators 252 and 253 are connected to the processor of the control part 256. Everything but the ultrasonic oscillators 252 and 253 of the flow rate measuring device 247 are made of PTFE. The inlet passage 248 is communicated with a shutoff valve 254, while the outlet passage 250 is communicated with a fluid control valve 255. The rest of the configuration of the eighth embodiment is similar to that of the fourth embodiment, so the explanation will be omitted.

Next, the operation of the fluid control system of the eighth embodiment of the present invention will be explained.

The fluid flowing into the fluid control system passes through the shutoff valve 254 and flows into the flow rate measuring device 247. The fluid flowing into the flow rate measuring device 247 is measured for flow rate in the straight passage 251. Ultrasonic vibration is propagated through the fluid flowing through the inside of the straight passage 251 from the ultrasonic oscillator 252 toward the ultrasonic oscillator 253. The Karman vortex generated downstream of the vortex generator 249 is generated at a period proportional to the flow rate of the fluid. Karman vortexes of different swirl directions are alternately generated, so the ultrasonic vibration is accelerated or decelerated in the direction of progression when passing through the Karman vortex due to the swirl direction of the Karman vortex. For this reason, the ultrasonic vibration received by the ultrasonic oscillator 253 fluctuates in frequency (period) due to the Karman vortexes. The ultrasonic vibration sent and received by the ultrasonic oscillators 252 and 253 are converted to electrical signals and output to the processor 257 of the control part 256. At the processor 257, the flow rate of the fluid flowing through the straight passage 251 is calculated based on the frequency of the Karman vortex obtained from the phase difference of the ultrasonic vibration output from the transmitting side ultrasonic oscillator 252 and the ultrasonic vibration output from the receiving side ultrasonic oscillator 253. The flow rate calculated by the processor 257 is converted to an electrical signal and output to the control part 258. The rest of the operation of the eighth embodiment is similar to that of the fourth embodiment, so an explanation will be omitted.

Due to the above operation, the ultrasonic type vortex flowmeter can accurately measure the flow rate even with a large flow rate since the greater the flow rate, the more vortexes are generated and exhibits a superior effect in fluid control of a large flow rate.

Note that the present invention was explained in detail based on specific embodiments, but a person skilled in the art could make various changes, modifications, etc. without departing from the claims and ideas of the present invention.

1. A fluid control system characterized by being provided with:
a fluid control valve controlling a pressure of a fluid by a pressure operation of a control fluid,
a flow rate measuring device measuring a flow rate of the fluid, converting a measurement value of said flow rate to an electrical signal, and outputting the signal, and
a control part outputting a command signal for controlling an opening area of said fluid control valve to said fluid control valve or a piece of equipment operating said fluid control valve based on a difference between said electrical signal from said flow rate measuring device and a set flow rate.

2. A fluid control system as set forth in claim 1 characterized by being further provided with a shutoff valve for opening or cutting off a flow of said fluid.

3. A fluid control system as set forth in claim 2 characterized by being further provided with a throttle valve able to be adjusted in opening area.

4. A fluid control system as set forth in claim 3 characterized in that said valve and said flow rate measuring device are directly connected without using any independent connecting means.

5. A fluid control system as set forth in claim 4 characterized in that said valve and said flow rate measuring device are arranged in a single base block.

6. A fluid control system as set forth in claim 4, wherein
said fluid control valve is provided with
a main body having a second cavity provided at a center of a bottom part and opening at a base part, an inlet passage communicating with the second cavity, a first cavity provided at a top part with a top face open and having a diameter larger than a diameter of the second cavity, an outlet passage communicating with the first cavity, and a communicating hole communicating the first cavity and second cavity and having a diameter smaller than the diameter of the first cavity, a top face of the second cavity made a valve seat;
a bonnet having inside it a cylindrical cavity communicating with an air feed hole and exhaust hole provided at a side face or top face and provided with a step part at an inner circumference of a bottom end;
a spring retainer inserted into the step part of the bonnet and having a through hole at its center;
a piston having at its bottom end a first connecting part with a smaller diameter than the through hole of the spring retainer, provided at its top part with a flange, and inserted inside the cavity of the bonnet to be vertically movable;
a spring supported gripped by a bottom end face of the flange of the piston and a top end face of the spring retainer;
a first valve mechanism having a first diaphragm having a peripheral edge fastened by being gripped between the main body and the spring retainer and having a center part forming a first valve chamber in a manner capping the first cavity of the main body made thick, a second connecting part provided at the center of its top face passing through the through hole of the spring retainer and fastened by being connected to the first connecting part of the piston, and a third connecting part provided at the center of its bottom face passing through the communicating hole of the main body;
a second valve mechanism having a valve element positioned inside the second cavity of the main body and provided in a larger diameter than the communicating hole of the main body, a fourth connecting part provided sticking out at the top end face of the valve element and being fastened by being connected with the third connecting part of the first valve mechanism, a rod provided sticking out from a bottom end face of the valve element, and a second diaphragm provided extending out from the bottom end face of the rod in the radial direction; and
a baseplate positioned below the main body, having at the center of its top part a projecting part fastening the peripheral edge of the second diaphragm of the second valve mechanism by gripping it with the main body, provided with a cut recess at a top end of the projecting part, and provided with a breathing hole communicating with the cut recess;
an opening area of a fluid control part formed by the valve element of the second valve mechanism and the valve seat of the main body changing along with vertical motion of the piston.

7. A fluid control system as set forth in claim 4 characterized in that said fluid control valve has a main body part formed from a fluid inlet passage, outlet passage, and chamber at which the inlet passage and outlet passage are communicated, a valve member having a valve element and a first diaphragm part, and a second diaphragm part and third diaphragm part positioned at the bottom part and top part of the valve member and having an effective pressure receiving area smaller than the first diaphragm part, the valve member and diaphragm parts being attached in the chamber by the outer circumferences of the diaphragm parts being fixed to the main body part, the diaphragm parts dividing the chamber into a first pressurization chamber, a second valve chamber, a first valve chamber, and a second pressurization chamber, the first pressurization chamber having means for applying a constant inwardly oriented force to the second diaphragm part, the first valve chamber communicating with the inlet passage, the second valve chamber having a valve seat corresponding to the valve element of the valve member and being formed divided into a bottom second valve chamber positioned at the first diaphragm part side with respect to the valve seat and communicating with the first valve chamber by a communicating hole provided in the first diaphragm part and a top second valve chamber positioned at the second diaphragm part side and provided communicating with the outlet passage and has a fluid control part where vertical motion of a valve member changes an opening area between the valve element and valve seat and controls a fluid pressure of the bottom second valve chamber, and the second pressurization chamber has means for applying a constant inwardly directed force to the third diaphragm part.

8. A fluid control system as set forth in claim 4 characterized in that said throttle valve is provided with
a main body formed with a valve seat face at a bottom face of a valve chamber provided at the top part and having an inlet passage communicating with a communicating port provided at the center of the valve seat face and an outlet passage communicating with the valve chamber,
a diaphragm comprised of a first valve element able to be inserted into the communicating port by an advancing/retracting motion of a stem in the axial direction and provided vertically from the center of the surface contacting the liquid, a ring-shaped projecting second valve element able to approach/separate from the valve seat face and formed at a position isolated from the first valve element in the radial direction, and a thin film part formed continuously from the second valve element toward the radial direction—all provided integrally,
a first stem fastened at its top part with a handle and having at an inner circumference of its bottom part a female thread part and having at its outer circumference a male thread part having a pitch large than a pitch of the female thread part,
a first stem support member having at its inner circumference a female thread part to be screwed with the male thread part,
a second stem having at an outer circumference of its top part a male thread part to be screwed with the female thread part of the first stem and connected at its bottom end with the diaphragm,
a diaphragm holder positioned below the first stem support member and supporting the second stem so as to be able to move vertically and not to be able to rotate, and
a bonnet fixing the first stem and diaphragm holder.

9. A fluid control system as set forth in claim 4 characterized in that said flow rate measuring device is an ultrasonic flowmeter or ultrasonic type vortex flowmeter.
